(19) United States
(12) Patent Application Publication
(10) Pub. No.: US 2021/0179804 A1
(43) Pub. Date: Jun. 17, 2021

(54) Fluorine-Containing Elastomer Compositions Including Microdiamond

(71) Applicant: Greene, Tweed Technologies, Inc., Wilmington, DE (US)

(72) Inventors: Gary Reichl, Coopersburg, PA (US); Eugene Gurevich, Coopersburg, PA (US)

(73) Assignee: Greene, Tweed Technologies, Inc.

(21) Appl. No.: 17/003,540

(22) Filed: Aug. 26, 2020

Related U.S. Application Data
(60) Provisional application No. 62/891,865, filed on Aug. 26, 2019.

(51) Int. Cl. C08K 3/04; C08L 27/18

(52) U.S. Cl. CPC C08K 3/04; C08K 2201/005; C08L 27/18

(57) ABSTRACT

A curable fluorine-containing elastomer compositions herein have at least one curable fluoropolymer having at least one fluorinated monomer and at least one fluorine-containing cure site monomer comprising at least one cure site; at least one curative; and microdiamond particles having an average particle size greater than 0.1 microns to about 100 microns. Such compositions may be fluorinated or perfluorinated. Articles formed from the compositions herein may be used at high service temperatures, and exhibit one or more of reduced particulation, reduced high-temperature compression set values, reduced sticking force, enhanced resistance to fluorine-based plasma, oxygen-based plasma, hydrogen-based plasma, and combinations thereof, and improved physical properties.

### CROSS-REFERENCE TO RELATED APPLICATIONS

This U.S. non-provisional patent application claims the benefit under 35 U.S.C. § 119(e) to U.S. provisional patent application No. 62/891,865, filed Aug. 26, 2019, entitled, “Fluorine-Containing Compositions Including Microdiamond,” the entire disclosure of which is incorporated herein by reference.

### BACKGROUND OF THE INVENTION

### Field of the Invention

The invention concerns fluoroelastomeric compositions incorporating microdiamond filler for providing one or more of the following properties: reduced particulation, reduced high-temperature compression set values, reduced sticking force, enhanced plasma resistance in fluorine-based plasma, oxygen-based plasma, hydrogen-based plasma and mixtures of such plasmas, the capability of use at high service temperatures, and improved physical properties.

### Description of Related Art

Fluorine-containing elastomers, including fluoroelastomers (FKM), perfluoroelastomers (FFKM) and blends thereof that include tetrafluoroethylene (TFE) and other partially or fully fluorinated monomers are known for their chemical resistance, solvent resistance and heat resistance, and therefore are widely used for sealing and other materials used in harsh environments. The characteristics of such materials required are highly specific to their end use and there continues to be an ever-increasing demand for highly resistant compounds, particularly FFKM compounds used in the semiconductor and other “clean” processes where contamination is to be avoided. In the fields of aeronautics, aerospace, semiconductor and chemical and pharmaceutical manufacturing, sealing properties under harsh chemical environments are encountered that can also be subject to extremely high temperature environments of not less than 350° C., and the ability of such materials to withstand such high temperature environments and/or harsh chemicals such as oxygen-based plasma, fluorine-based plasma and/or hydrogen-based plasma have become increasingly important. Thus, there is a need in the art to develop elastomers while attempting to reduce particulation from seals, reduce compression set, particularly at higher operating temperatures, enhance plasma resistance and reduce sticking force as well as improving physical properties. Developing elastomeric sealing compositions that can achieve such capabilities and operate in such harsh environments is a continuing need in the art.

It is the goal to use such good, high-temperature and environmentally-resistant materials to form molded parts, such as seals and gaskets, that are capable of withstanding deformation and that hold up in such rigorous conditions. While strength and other physical properties benefit from filler loading, typically the addition of additives can have a negative impact on compression set and other elastomeric sealing properties, and on plasma resistance and sticking properties. Thus, it is necessary to carefully select and balance the fillers used to achieve sufficient strength, low sticking force and the ability to withstand harsh plasma and high temperature conditions as well as to maintain adequate sealing properties such as a reasonably low compression set.

FFKM materials are typically prepared from perfluorinated monomers, including at least one perfluorinated cure site monomer having a functional group with a cure site. The monomers are polymerized to form a curable perfluorinated polymer having the cure sites thereon which are intended for cross-linking upon reaction with a curative or curing agent. Upon curing (cross-linking), the materials form an elastomeric material. Typical FFKM compositions include a perfluoropolymer, a curing agent that will react with the reactive cure site group on the cure site monomer, and any desired fillers. The resulting cured perfluoroelastomeric material exhibits elastomeric characteristics. FKMs generally include also one or more perfluorinated monomers, but may also incorporate non-perfluorinated monomers such as vinylidene fluoride, which can act as a monomer and cure site.

FFKMs and/or FKMs are also generally known for use as O-rings and in related sealing parts for high-end sealing applications. Particularly FFKMs are sought for use due to their high degree of heat-resistance, and resistance to plasma, chemicals and other harsh environments. There continues to be development of new perfluoroelastomeric compositions to meet the ever-increasing demands and challenges and provide ever higher levels of thermal, chemical and/or plasma resistance as well as to develop suitable physical properties for various end uses, continue to try to reduce particulation, maintain or lower compression set, particularly at high temperatures, and lower sticking force. Industry demands, particularly in the semiconductor area, continue to require enhanced performance of such seals to meet new, end-use applications that have increasingly aggressive environments as well as lower and lower contamination and particulation requirements, while maintaining sufficient elastomeric sealing properties, physical strength and low sticking properties. Thus, there is always a need for better properties but using low particulation compounds, i.e., those that introduce little or no harmful contaminants into the end use environment.

The fillers and combinations of fillers used to achieve targeted properties, as well as elastomer properties in the prior art include both inorganic and organic fillers. Typical fillers known in the semiconductor and other industries include carbon black, silica, alumina, TFE-based fluoroplastics, barium sulfate, fluorinated graphite, nanodiamonds, treated carbon and other polymers and plastics. Fillers used in some FFKM compositions for semiconductor applications include various fluoroplastic filler particles formed of polytetrafluoroethylene (PTFE) or perfluorinated copolymers such as copolymers of tetrafluoroethylene (TFE) and hexafluoropropylene (HFP) (also referred to as FEP-type copolymers) or of TFE and perfluoroalkylvinyl ethers (PAVEs) (known as PFA-type copolymers).

Such FFKM and/or FKM compositions can include only a single curable polymer, or sometimes blends of one or more such curable polymers. There are also fluorine-containing elastomers that have a single cure site on a cure site monomer in the curable perfluoropolymer used in the composition, or more than one cure site monomer having the same or different cure sites.

There are many potential combinations of materials that may be used, and the challenge is achieving higher thermal, chemical- and plasma-resistant properties for various end applications without sacrificing mechanical and sealing properties, such as compression set, and preferably improving such properties.

One attempt to introduce plasma-resistant properties can be found in U.S. Patent Application Publication No. 2009/0023852 A1 which describes a fluorine-containing elastomer composition for use in preparing a molded article having a small weight change when exposed to NF₃, O₂ and CF₄ plasma. The composition includes a fluorine-containing elastomer and a nano-sized carbon allotrope with an average particle size of at most 0.1 micron, which allotrope may be a diamond. This publication teaches that particle sizes over 0.1 micron create problems and impact semiconductor defect rates, indicating that if the individual particle sizes in a filler are more than 0.1 micron, the filler should be pulverized further such that it would be made into a smaller size.

U.S. Pat. No. 6,946,513 B2 provides an elastomer composition prepared using a clean filler that is suitable as a molding material for semiconductor production apparatuses. The filler may be a carbon filler, such as carbon black, graphitized carbon or graphite. The filler may be in the form of a particle or fiber, wherein the particle size is preferably not more than 5 microns.

U.S. Pat. No. 9,725,582 B2 provides a fluororesin composition for a molded product that has good tensile strength. The fluororesin composition includes a fluororesin and a fluorinated nanodiamond present in an amount of 0.001 to 5% mass based on the fluororesin. The fluorinated nanodiamond is described as a powder having an average particle size of 0.001 to 1 micron.

International Patent Publication No. WO 2016/104604 A1 describes a fluorine-containing elastomer composition used to form molded articles having improved chemical-resistance, solvent-resistance, and heat-resistance. The sealing material also demonstrates improved plasma-resistance and can be used in the working chamber of a semiconductor manufacturing apparatus. The composition includes a fluorine-containing elastomer with 0.0001-4 mass parts fullerene with respect to 100 mass parts of the fluorine-containing elastomer.

U.S. Pat. No. 9,512,302 B2 provides a fluoropolymer coating with improved tribological properties. In one aspect, the invention relates to a slurry composition of a fluoropolymer and nanodiamond particles having specific properties. The nanodiamond particles may be in single or agglomerated form, and the particle size is preferably between 0.008 microns and 0.030 microns. The concentration of the nanodiamond in the slurry is at most 5% by weight.

While as noted above, there have been attempts in the prior art to integrate a highly plasma-resistant carbon-based filler into fluoroelastomers and perfluoroelastomers, as such materials lack the strength of a resin, the use of a high-strength particle such as a nanodiamond has been taught as being unfavorable when the particle size increases due to defect rates, which are typically associated with particulation or other factors and are also not believed to provide strength without loss of good elastomeric properties in such materials. Thus, there remains a need in the art to achieve such adequate physical properties or to improve them while retaining elastomeric sealing properties and improving the resistance to harsh plasma environments.

### BRIEF SUMMARY OF THE INVENTION

The invention herein includes a curable fluorine-containing elastomer composition comprising at least one curable fluoropolymer comprising at least one fluorinated monomer, and at least one fluorine-containing cure site monomer comprising at least one cure site; and microdiamond particles having an average particle size of greater than 0.10 micron to about 100 microns.

In one embodiment, the microdiamond particles may have an average particle size of greater than 0.1 micron to about 10 microns, or may have an average particle size of about greater than 0.1 micron to about 5 microns. The average particle size of the microdiamonds may also be about 0.20 micron to about 2 microns, or may be about 0.25 micron to about 1 micron. In further embodiments, the microdiamond particles may have an average particle size of about 0.25 micron to about 0.5 micron. The microdiamond particles may have a shape selected from spherical particles, fibers or flasks. The microdiamond particles may be natural and/or synthetic microdiamond particles. The particles may be present in an agglomerated or aggregate form.

In one embodiment, the composition comprises about 0.1 to about 100 parts of microdiamond particles per 100 parts by weight of the at least one curable fluoropolymer, and preferably comprises about 1 to about 50 parts of microdiamond particles per 100 parts by weight of the at least one curable fluoropolymer. More preferably, the composition comprises about 2 parts to about 20 parts per 100 parts by weight of the at least one curable fluoropolymer.

The at least one curable fluoropolymer may be a curable perfluoropolymer, wherein the at least one fluorinated monomer is tetrafluoroethylene and the perfluoropolymer may further comprise a perfluoroalkylvinyl ether monomer, and the at least one fluorine-containing cure site monomer may be a perfluorinated cure site monomer.

In another embodiment, the at least one curable fluoropolymer may be a curable perfluoropolymer, the at least one fluorinated monomer may be tetrafluoroethylene, the curable perfluoropolymer may further comprise a perfluoroalkylvinyl ether monomer, and the curable perfluoropolymer may comprise fluoroplastic particles therein.

In each of the embodiments of the composition noted above, the composition may also comprise at least one curative that may be incorporated a curative into the fluorine-containing elastomer composition before curing the composition. In one embodiment, the at least one curative may be a peroxide cure system.

The curable fluoropolymer may also be a first perfluoropolymer, wherein the at least one fluorinated monomer is tetrafluoroethylene and the perfluoropolymer further comprises a perfluoroalkylvinyl ether monomer, and wherein there are at least two of the fluorine-containing cure site monomers, each having at least one cure site and the composition includes two or more curatives, one of which may be a peroxide cure system. In such an embodiment, the curable fluorine-containing elastomer composition may comprise a blend of such a curable perfluoropolymer with a second curable perfluoropolymer comprising tetrafluoroethylene, a second perfluoroalkylvinyl ether monomer and a perfluorinated cure site monomer, and wherein the second perfluoropolymer comprises fluoroplastic particles therein, and may also comprise at least two curatives, one of which may be a peroxide cure system.

In such an blended fluoropolymer embodiment, a range of a ratio of a weight percent of first curable perfluoropolymer to a weight of the second curable perfluoropolymer may be about 5:95 to about 95:5, about 20:80 to about 80:20, about 40:60 to about 60:40 or about 50:50.

Also in such an embodiment, the at least two cure site monomers of the first curable perfluoropolymer may each be present in an amount of about 0.1 to about 10 mole percent in the first curable perfluoropolymer and the at least one cure site monomer of the second curable perfluoropolymer may be present in an amount of about 0.1 to about 10 mole percent in the second curable perfluoropolymer. Further, the cure sites in at least two cure site monomers in the first curable perfluoropolymer may be nitrogen-containing cure sites. In such a case, the first curable perfluoropolymer may comprise a first cure site monomer comprising a primary cyano cure site and a second cure site monomer comprising a secondary cyano cure site.

In the blended embodiment, the at least one cure site in each of the at least two cure site monomers in the first curable perfluoropolymer may be selected from the group consisting of cyano, carboxyl, carbonyl, alkoxycarbonyl, and combinations thereof.

In the method noted above, the method may also comprise incorporating at least one curative into the fluorine-containing elastomer composition before curing the composition, and in a preferred embodiment including at least two curatives. Further, the at least two curatives may be present in the blended composition in a total amount of about 0.2 to about 10 parts by weight per 100 parts by weight of the curable perfluoropolymers in the composition. In such an embodiment further, each of the at least two curatives may be present in the composition in an amount of about 0.1 part to about 6 parts by weight per 100 parts by weight of the curable perfluoropolymers. In a further blended embodiment, the at least two curatives may comprise a first curative that is present in the composition in an amount of about 0.5 part to about 4 parts by weight per 100 parts by weight of the curable perfluoropolymers, and a second curative that is present in the composition in an amount of about 0.3 part to about 2 parts by weight per 100 parts by weight of the curable perfluoropolymers. In one embodiment, the first curative is

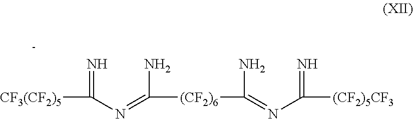

and the second curative is

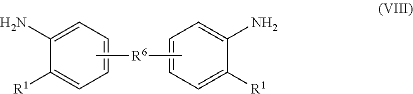

wherein each R¹ is independently —NH₂, —NHR₂, —OH or —SH; R² is a monovalent organic group; and wherein R⁶ is —SO₂, —O—, —CO—, an alkylene group of 1 to about 6 carbon atoms, a perfluoroalkylene group of 1 to about 10 carbon atoms, a single bond or a group as shown in Formula (IX):

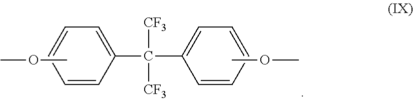

In a further embodiment, the second curative is a compound according to formula (X):

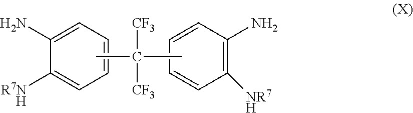

wherein R⁷ is independently selected from hydrogen, an alkyl group of 1 to about 10 carbon atoms; a partially fluorinated or perfluorinated alkyl group of 1 to 10 carbon atoms; a phenyl group; a benzyl group; or a fluorinated or partially fluorinated phenyl group; a fluorinated or partially fluorinated benzyl group; or a phenyl or an alkyl group having a function group or groups that is a lower alkyl or perfluoroalkyl group.

In another preferred embodiment, the second curative may be bisaminophenol or a salt thereof.

The second curable perfluoropolymer may also comprise a cure site monomer having a cure site selected from the group consisting of halogen, nitrogen-containing groups, carboxyl, alkoxycarbonyl and combinations thereof.

In another preferred embodiment, at least two curatives are selected from the group consisting of:

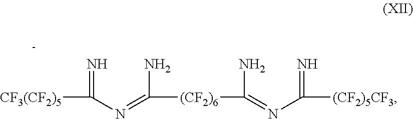

bisaminophenol and combinations thereof.

In a further preferred embodiment, he first curative may be a compound according to claim (XII) and the second curative may be bisaminophenol.

In one embodiment of the invention of the curable fluorine-containing elastomer composition, the composition may comprise a second curable fluoropolymer comprising tetrafluoroethylene and at least one second fluorine-containing monomer, one of which is a cure site monomer comprising at least one second cure site.

In such an embodiment, the first curable fluoropolymer and/or the second curable fluoropolymer may be a perfluoropolymer, and the first curable fluoropolymer and the second curable fluoropolymer are preferably different.

The invention further includes a cured fluorine-containing elastomer formed by curing the curable fluorine-containing compositions noted above.

The invention also includes a molded article formed by heat curing and shaping a compositions noted above.

The invention further includes a method for forming a fluoroelastomeric article with reduced particulation, comprising: preparing a curable fluorine-containing elastomer composition comprising at least one curable fluoropolymer comprising at least one fluorinated monomer and at least one fluorine-containing cure site monomer comprising at least one cure site; adding into the curable fluorine-containing elastomer composition microdiamond particles having an average particle size of greater than 0.10 microns to about 100 microns; and curing the curable fluorine-containing elastomer composition to form the fluoroelastomeric article, wherein the fluoroelastomeric article has reduced particulation in comparison to a second fluoroelastomeric article having the same fluorine-containing elastomer composition but that does not include the microdiamond particles, when the fluoroelastomeric article and the second fluoroelastomeric article are exposed to a fluorine-based plasma, an oxygen-based plasma, a hydrogen-based plasma, and combinations thereof.

In such a method, the curable fluorine-containing elastomer composition may further include at least one filler and the method may further comprise adding the microdiamond particles into the fluorine-containing elastomer composition while adding the at least one filler to the at least one first curable fluoropolymer.

In the method noted above, the at least one curable fluoropolymer may be a perfluoropolymer, the fluorinated monomer may be tetrafluoroethylene, the at least one fluorine-containing cure site monomer may be a perfluorinated cure site monomer and the perfluoropolymer may further comprise a perfluoroalkyl vinyl ether.

In the method noted above, the method may also comprise incorporating a curative into the fluorine-containing elastomer composition before curing the composition.

In the method, the fluoroelastomeric article preferably also has a compression set value at 250° C./70 hours/25% deflection that is reduced in comparison to the second fluoroelastomeric article. In such an embodiment, the curable fluorine-containing elastomer composition used to form the second fluoroelastomeric article may further comprise a carbon black filler.

In the method, the fluoroelastomeric article preferably also has a reduced sticking force in comparison to the second fluoroelastomeric article. In such an embodiment, the curable fluorine-containing elastomer composition used to form the second fluoroelastomeric article may further comprise a carbon black filler.

In the method, the fluoroelastomeric article preferably further has improved resistance to a fluorine-based plasma, an oxygen-based plasma, a hydrogen-based plasma, and combinations thereof in comparison to the second fluoroelastomeric article.

In the method, the fluoroelastomeric article preferably further has improved physical properties in comparison to the second fluoroelastomeric article.

In the method, the compression set value of the fluoroelastomeric article at 350° C./70 hours/18% deflection is preferably also reduced in comparison to the second fluoroelastomeric article. In such an embodiment, the curable fluorine-containing elastomer composition used to form the second fluoroelastomeric article may further comprise a carbon black filler.

The invention also includes a method of forming an fluoroelastomeric article having reduced compression set, comprising: preparing a curable fluorine-containing elastomer composition comprising at least one first curable fluoropolymer comprising at least one fluorinated monomer, and at least one fluorine-containing cure site monomer comprising at least one cure site; adding into the curable fluorine-containing elastomer composition microdiamond particles having an average particle size of greater than 0.10 microns to 100 microns; and curing the curable fluorine-containing elastomer composition to form the fluoroelastomeric article, wherein the fluoroelastomeric article has a compression set value at 250° C./70 hours/25% deflection that is reduced in comparison to an second fluoroelastomeric article formed of the same curable fluorine-containing elastomer composition, but that does not include the microdiamond particles.

In such a method the at least one curable fluoropolymer may be a perfluoropolymer, the fluorinated monomer is tetrafluoroethylene, the at least one fluorine-containing cure site monomer may be a perfluorinated cure site monomer and the perfluoropolymer may further comprise a perfluoroalkyl vinyl ether.

In the method noted above, the method may also comprise incorporating a curative into the fluorine-containing elastomer composition before curing the composition.

In the method, the fluoroelastomeric article preferably also has reduced particulation in comparison to the second fluoroelastomeric article when the fluoroelastomeric article and the second fluoroelastomeric article are exposed to a fluorine-based plasma, an oxygen-based plasma, a hydrogen-based plasma, and combinations thereof. In such an embodiment of the method, the curable fluorine-containing elastomer composition used to form the second fluoroelastomeric article further comprises a carbon black filler.

In the method, the fluoroelastomeric article preferably also has a reduced sticking force in comparison to the second fluoroelastomeric article. In such an embodiment, the curable fluorine-containing elastomer composition used to form the second fluoroelastomeric article may further comprise a carbon black filler.

In the method, the fluoroelastomeric article preferably also has improved resistance to a fluorine-based plasma, an oxygen-based plasma, a hydrogen-based plasma, and combinations thereof in comparison to the second fluoroelastomeric article.

In the method, the fluoroelastomeric article preferably also has improved physical properties in comparison to the second fluoroelastomeric article.

In the method, the compression set value of the fluoroelastomeric article at 350° C./70 hours/18% deflection is preferably also reduced in comparison to the second fluoroelastomeric article. In such an embodiment of the method, the curable fluorine-containing elastomer composition used to form the second fluoroelastomeric article may further comprise a carbon black filler.

The invention also includes a method of forming an fluoroelastomeric article having a reduced sticking force, comprising: preparing a curable fluorine-containing elastomer composition comprising at least one first curable fluoropolymer comprising at least one fluorinated monomer, and at least one fluorine-containing cure site monomer comprising at least one cure site; adding into the curable fluorine-containing elastomer composition microdiamond particles having an average particle size of greater than 0.10 microns to 100 microns; and curing the curable fluorine-containing elastomer composition to form the fluoroelastomeric article, wherein the fluoroelastomeric article has a sticking force that is reduced in comparison to a second fluoroelastomeric article formed of the same curable fluorine-containing elastomer composition as the curable fluorine-containing elastomer, but that does not include the microdiamond particles.

In the method, the at least one curable fluoropolymer may be a perfluoropolymer, the fluorinated monomer may be tetrafluoroethylene, the at least one fluorine-containing cure site monomer may be a perfluorinated cure site monomer and the perfluoropolymer may further comprises a perfluoroalkyl vinyl ether.

In the method noted above, the method may also comprise incorporating a curative into the fluorine-containing elastomer composition before curing the composition.

In the method, the fluoroelastomeric article preferably also has a compression set value at 250° C./70 hours/25% deflection that is reduced in comparison to the second fluoroelastomeric article. In such an embodiment, the curable fluorine-containing elastomer composition used to form the second fluoroelastomeric article may further comprise a carbon black filler.

In the method, the fluoroelastomeric article preferably also has reduced particulation in comparison to the second fluoroelastomeric article when the fluoroelastomeric article and the second fluoroelastomeric article are exposed to a fluorine-based plasma, an oxygen-based plasma, a hydrogen-based plasma, and combinations thereof. In such an embodiment of the method, the curable fluorine-containing elastomer composition used to form the second fluoroelastomeric article may further comprise a carbon black filler.

In the method, the fluoroelastomeric article preferably also has improved resistance to a fluorine-based plasma, an oxygen-based plasma, a hydrogen-based plasma, and combinations thereof in comparison to the second fluoroelastomeric article.

In the method, the fluoroelastomeric article preferably also has improved physical properties in comparison to the second fluoroelastomeric article.

In the method, the compression set value of the fluoroelastomeric article at 350° C./70 hours/18% deflection is preferably reduced in comparison to the second fluoroelastomeric article. In such an embodiment, the curable fluorine-containing elastomer composition used to form the second fluoroelastomeric article may further comprise a carbon black filler.

The invention further includes a method for forming a fluoroelastomeric article with reduced particulation, comprising: preparing a curable fluorine-containing elastomer composition comprising at least one curable fluoropolymer comprising at least one fluorinated monomer, and at least one fluorine-containing cure site monomer comprising at least one cure site; adding into the curable fluorine-containing elastomer composition microdiamond particles having an average particle size of greater than 0.10 microns to about 100 microns; and curing the curable fluorine-containing elastomer composition to form the fluoroelastomeric article, wherein the fluoroelastomeric article is capable of being used in service temperatures of at least about 350° C.

In the method noted above, the method may also comprise incorporating a curative into the fluorine-containing elastomer composition before curing the composition.

In the method, the fluoroelastomeric article may be a perfluoroelastomeric article. In the method, the fluoroelastomeric article preferably has a compression set value at 350° C./70 hours/18% deflection that is reduced in comparison to a second fluoroelastomeric article formed of the same curable fluorine-containing elastomer composition, but that does not include the microdiamond particles. In such an embodiment, the curable fluorine-containing elastomer composition used to form the second fluoroelastomeric article further comprises a carbon black filler.

### DETAILED DESCRIPTION OF THE INVENTION

As noted in the Background Section, the prior art indicates that use of diamond nanoparticles with sizes greater than 0.1 micron would cause high defect rates which are typically associated with particulation. Applicants have surprisingly found that use of particles of microdiamond larger than 0.1 micron provide lower particulation than known competitive, plasma-resistant compositions. Further, in preferred embodiments herein, such fillers unexpectedly also lead to reduced compression set values, even at high temperatures, reduced sticking force, enhanced resistance to fluorine-based plasma, oxygen-based plasma, hydrogen-based plasma, and combinations thereof, and improved physical properties, and in further preferred embodiments allows for use in high service temperatures with reduction of compression set.

The curable fluorine-containing elastomer composition includes at least one curable fluoropolymer comprising tetrafluoroethylene, and at least one fluorine-containing monomer, one of which is a cure site monomer comprising at least one cure site; and microdiamond particles. It may optionally also incorporate at least one curative.

Preferred microdiamond particles have an average particle size of greater than 0.1 micron to about 100 microns, and may be synthetic microdiamonds, natural microdiamonds or blends and combinations thereof. As used herein, “average particle size,” is intended to mean the peak of the largest particle size curve characterizing the particle size distribution. If the microdiamond particles are purchased commercially, the commercial source will typically indicate the average particle size, but such average particle size can be independently measured by any suitable method known in the art or to be developed. Preferred average particle size for achieving improved physical properties and enhanced plasma resistance, e.g., in NF₃ and/or O₂ and/or H plasma, in various embodiments herein may be greater than 0.1 micron to about 10 microns; greater than 0.1 micron to about 5 microns; about 0.2 micron to about 2 microns; about 0.25 microns to about 1.0 micron and about 0.25 microns to about 0.5 microns depending on the end properties desired and the expected loading in a particular polymer system. In other preferred embodiments, average particle sizes of about 2 microns to about 5 microns can be used while still achieving low levels of particulation compared to compounds currently marketed for such plasma environments and unexpectedly low compression set values, even at higher temperatures, such as about 250° C. and higher, about 300° C. and higher, and about 350° C. and higher.

The microdiamond particles may have various shapes including spherical particles, fibers or flasks. Further the particles may be present in an agglomerated or aggregate form. Suitable commercial grade microdiamonds are sold for use in abrasive surfaces (such as on tools), from a variety of sources including The Dev Group, Dev Industrial Corp. in Boca Raton, Fla., U.S.A., Eastwind Diamond Abrasives of Vermont, U.S.A., American Superabrasives, of Florida, U.S.A., Zhecheng Hongxiang Superhard Material Co., Ltd., China and other abrasive synthetic diamond manufacturers or suppliers of synthetic or natural microdiamond.

The composition may typically include up to about 100 parts of microdiamond by weight per 100 parts of the base fluoropolymer or fluoropolymers used in the composition although more or less may be incorporated for different property effects. In some embodiments, the composition may preferably include about 1 to about 50 parts by weight of microdiamond per 100 parts of the base fluoropolymer(s), or about 2 parts to about 20 parts per 100 parts of the base fluoropolymer(s). The nature of the microdiamond allows for excellent results and a good balance of physical and elastomeric properties at lower levels of about 0.5 to about 10 parts by weight per 100 parts by weight of the base curable fluoropolymer(s), about 0.5 part by weight to about 5 parts by weight, or as low as about 2.75 to about 5 parts by weight per 100 parts by weight of the base fluoropolymer(s). It is also the case that at the preferred levels an unexpectedly favorable or decreased level of compression set is achieved.

It is preferred to keep the loading at about 0.5 to about 50 parts per 100 parts of the base fluoropolymer(s) to avoid impacting and/or to achieve a benefit to the improved properties achieved herein, and should take into account the total loading of other typical fillers in such compositions. It should be noted that a goal for the compositions herein is to provide sufficient strength and physical properties without overly impacting elastomeric properties such as compression set in a negative manner, and/or while also preferably enhancing the plasma resistance in fluorine-based plasma, oxygen-based plasma, hydrogen-based plasma, and combinations of these plasmas, reducing sticking force and/or reducing particulation in articles formed of the compositions. In attempting to achieve such goal, the compositions further are able to function in such harsh environments also at elevated temperatures while, in some cases, improving the compression set and allowing for high service temperatures. Such balanced properties can economically and beneficially be achieved in the present invention at far lower loading of the microdiamond, such that compositions having only about 1 to about 20 parts of microdiamond can provide excellent results, save on filler costs and provide reduced particulation, reduced high-temperature compression set values, reduced sticking force, enhanced plasma resistance in fluorine-based plasma, oxygen-based plasma, hydrogen-based plasma, and combinations of these plasmas, and improved physical properties.

The curable fluoropolymer may be any suitable curable fluoropolymer, including compositions which are useful in harsher environments such as those encountered in oilfield industrial use or petrochemical processing, but in this instance are also suitable for use in clean environments. Curable fluoropolymers which may be used are such materials as are classified by the Standard Rubber Nomenclature definitions provided by ASTM International in ASTM D1418-17. Standard FKM polymers in accordance with such elastomer nomenclature typically have at least two monomers, one of which is fluorinated, and preferably all of which are fluorinated to some degree, with at least one cure site monomer for use in vulcanization. The at least two monomers preferably include vinylidene fluoride and hexafluoropropylene or a similar fluorinated olefin, but may include a variety of other monomers as well that are known or to be developed in the art. The fluoroelastomer composition may also include at least one curing agent that is capable of undergoing a crosslinking reaction with a functional group in the cure site monomer(s) of the fluoroelastomer.

With respect to the FKMs herein, such cure site monomer(s) may include one cure site monomer which is curable by a peroxide curing system. Such cure site monomer preferably has a functional group comprising a halogenated material, such as Br or I in the cure site functional group. While at least two of the monomers in an FKM may be hexafluoropropylene (HFP) and vinylidene fluoride (VF2), other typical monomers may be used in addition to these two for forming a variety of fluoropolymers known in the art, and the cure site monomer and cure system may vary. By a “peroxide curing system,” it is meant that a peroxide curative and any associated co-curative are employed. Such systems are known in the art.

The curable fluoropolymers may be radiation crosslinkable, but are preferably crosslinkable (curable) through a cure system wherein a curing agent(s) is/are added that is/are capable of reacting with a functional group(s) in the cure site monomer for form an elastomeric material. Optionally, at least one of a second curing agent, a co-curing agent, and/or a cure accelerator(s) may be employed as well. The compositions herein may have a single curable fluoropolymer or a combination of at least two curable fluoropolymers, in the form of, for example, a polymer blend, grafted composition or alloy, depending on desired end properties.

The terms “uncured” or “curable,” refer to fluoropolymers for use in compositions herein, which have not yet been subjected to crosslinking reactions in any substantial degree such that the material is not yet sufficiently cured for the intended end application.

The curable fluoropolymer for the compositions herein may optionally include additional such polymers in blend-like compositions or grafted/copolymerized compositions as noted above. Further, the polymer backbones may include a variety of cure site monomer(s) along the chain to provide one or more different functional groups for crosslinking, however, preferably one of such groups, for use in the invention herein, is curable by a peroxide curing system. The compositions may also include curing agents and co-curing agents and/or accelerators to assist in the cross-linking reactions. Additional cure sites and curing systems may be provided to the same or a different cure site monomer, such as cure sites that react with a bisphenyl-based curing system for creating cross-linking, for example, those cure sites that have a nitrogen-containing reactive group, provided that the peroxide curable functional group is preferably also present. Consequently, while the disclosure herein discusses a variety of preferred curatives (also referred to herein as crosslinking agents or curing agents), when additional cure sites known in the art are used, other curatives that are capable of curing such alternative cure sites may also be used in addition to the organic peroxide-based curatives and co-curatives preferred herein. Further description of such cure systems is provided below.

One or more curable fluoropolymer(s) may be present in such compositions. Such polymers are themselves formed by polymerizing or co-polymerizing one or more fluorinated monomers. Various techniques known in the art (direct polymerization, emulsion polymerization and/or free radical initiated polymerization, latex polymerization, etc.) can be used to form such polymers.

The fluoropolymer may be formed by polymerizing two or more monomers, preferably one of which is at least partially fluorinated, although fully fluorinated monomers may be used as well. For example, HFP and VF2 are preferably combined with tetrafluoroethylene (TFE) or one or more perfluoroalkyl vinyl ethers (PAVE), or similar monomers along with at least one monomer which is a cure site monomer to permit curing, i.e.

at least one fluoropolymeric cure site monomer. A fluoroelastomer composition as described herein may include any suitable standard curable fluoroelastomeric fluoropolymer(s) (FKM) capable of being cured to form a fluoroelastomer, preferably using a cure system and one or more other curing agents as described herein. Examples of suitable curable FKM fluoropolymers include those sold under the trade name Tecnoflon® PL958 available from Solvay Solexis, S.p.A., Italy or other similar fluoropolymers which, when employed in the compositions herein, preferably are curable by a peroxide cure system. Other suppliers of such materials include Daikin Industries, Japan; 3M Corporation, Minnesota; and E.I. DuPont de Nemours & Company, Inc., Delaware, among others. Such FKM polymers are not fully fluorinated on the backbone of the polymer.

In preferred embodiments, particularly for end applications in high purity or clean environments, the at least one first curable fluoropolymer is a curable perfluoropolymer that will be useful for forming a perfluoroelastomer. A composition herein, whether a curable fluoropolymer composition or perfluoropolymer composition may include only one fluoro- or perfluoropolymer or may include two or more such fluoro- or perfluoropolymers in the composition which when used and/or cured to would form either a single fluoro- or perfluoroelastomer, or when two or more are used, would form a perfluoroelastomeric blended composition. Further curable fluoropolymers may be blended with curable perfluoropolymers to make partially fluorinated blended fluoroelastomers.

As used in this application, “perfluoroelastomer” or “cured perfluoroelastomer” unless otherwise indicated, includes any cured elastomeric material or composition that is formed by curing a curable perfluoropolymer(s) such as the preferred curable perfluoropolymers in the curable compositions described herein.

A “curable perfluoropolymer” (sometimes referred to in the art as a “perfluoroelastomer” or more appropriately a “perfluoroelastomer gum”) that is suitable to be used to form a cured perfluoroelastomer is a polymer that is substantially completely fluorinated, and which is preferably completely perfluorinated, on its polymeric backbone. It will be understood, based on this disclosure, that some residual hydrogen may be present in some perfluoroelastomers within the crosslinks of those materials due to use of hydrogen as part of a functional crosslinking group. Cured materials, such as perfluoroelastomers are cross-linked polymeric structures.

The curable perfluoropolymers that are used in preferred perfluoroelastomeric compositions herein to form cured perfluoroelastomers upon cure are formed by polymerizing one or more perfluorinated monomers, one of which is preferably a perfluorinated cure site monomer having a cure site, as noted above, i.e., a functional group to permit curing. The functional group may either be or may include a reactive group that may not be perfluorinated.

Two or more curable fluoro- or perfluoropolymers, and preferably at least one optional curative (curing agent), may be preferably combined herein in a composition that is then cured forming the resulting crosslinked, cured fluoroelastomeric compositions, and preferably perfluoroelastomeric compositions as described herein.

As used herein, the curable fluorine-containing elastomeric compositions may be curable perfluoropolymer compositions which are blended and combined compositions formed from two or more curable polymers, each of which, if perfluorinated, is formed by polymerizing two or more perfluorinated monomers, including at least one perfluorinated cure site monomer which has at least one functional group (cure site) to permit curing. Such curable perfluoropolymer materials are also referred to generally as FFKMs in accordance with the American Standardized Testing Methods (ASTM) standardized rubber definitions and as described above herein in ASTM Standard D1418-17, incorporated herein by reference in relevant part.

As used herein, “compression set” refers to the propensity of an elastomeric material to remain distorted and not return to its original shape after a deforming compressive load has been removed. The compression set value is expressed as a percentage of the original deflection that the material fails to recover. For example, a compression set value of 0% indicates that a material completely returns to its original shape after removal of a deforming compressive load. Conversely, a compression set value of 100% indicates that a material does not recover at all from an applied deforming compressive load. A compression set value of 30% signifies that 70% of the original deflection has been recovered. Higher compression set values generally indicate a potential for seal leakage.

As described herein, the invention includes curable fluorine-containing elastomer compositions, preferably curable perfluoroelastomer compositions, and cured perfluoroelastomer compositions and molded articles formed from such curable fluorine-containing elastomer compositions.

Such perfluoroelastomeric compositions preferably include at least one, and more preferably two or more curable perfluoropolymers, preferably perfluoro-copolymers, at least one of which has a high content of tetrafluoroethylene (TFE). Other suitable co-monomers may include other ethylenically unsaturated fluoromonomers. If two such perfluoropolymers are used in a blend, and both preferably have TFE or another similar perfluorinated olefin monomer, at least one of the perfluoropolymers may be a high-TFE perfluoropolymer. Each polymer may also preferably have one or more perfluoroalkylvinyl ethers (PAVEs), which include alkyl or alkoxy groups that may be straight or branched and which may also include ether linkages, wherein preferred PAVEs for use herein include, for example, perfluoromethylvinyl ether (PMVE), perfluoroethylvinyl ether (PEVE), perfluoropropylvinyl ether (PPVE), perfluoromethoxyvinyl ether and other similar compounds, with especially preferred PAVEs being PMVE, PEVE and PPVE, and most preferred being PMVE which provides excellent mechanical strength to resulting articles formed from curing the curable compositions herein. The PAVEs may be used alone or in combinations of the above-noted PAVE types within the curable perfluoropolymers and in the ultimate curable compositions so long as the use is consistent with the invention as described herein.

Preferred perfluoropolymers are co-polymers of TFE, at least one PAVE, and at least one perfluorinated cure site monomer that incorporates a cure site or functional group to permit crosslinking of the curable polymer. The cure site monomers may be of a variety of types with preferred cure sites noted herein. Preferred cure sites preferably are those having a nitrogen-containing group, however, other cure site groups such as carboxyl groups, alkylcarbonyl groups, or halogenated groups having, e.g., iodine or bromine as well as other cure sites known in the art may also be used, particularly since additional curable fluoropolymers or perfluoropolymers beyond a first and/or second curable perfluoropolymer may be provided to the composition. Consequently, while the disclosure herein provides for radiation curing or use of a variety of preferred curatives (also referred to herein as crosslinking agents, curing agents), if other cure sites known in the art are used, other curatives that are capable of curing such alternative cure sites may also be used. For example, peroxide curing systems, such as those based on an organic peroxide, and related peroxide co-curatives may be used with halogenated functional cure site groups. It is most preferred that both the first and the second perfluoropolymers include nitrogen-containing cure sites.

Exemplary cure site monomers are listed below and may be used in the curable fluoropolymer(s) or curable perfluoropolymer(s) described herein for use in the curable compositions, most of which are PAVE-based in structure and have a reactive site. Although the polymers may vary, preferred structures are those having the following structure (A):

CF₂═CFO(CF₂CF(CF₃)O)ₘ(CF₂)ₙ—X¹ (A)

wherein m is 0 or an integer from 1 to 5, n is an integer from 1 to 5 and X¹ is a nitrogen-containing group, such as nitrile or cyano. However, carboxyl groups, alkoxycarbonyl groups or halogenated end groups may also be used as X¹.

Most preferably the cure site monomer in any curable fluoropolymer or curable perfluoropolymer, or in blend of two curable perfluoropolymers in either or both of the first and the second of such curable perfluoropolymers is in accordance with (A) noted above, wherein m is 0 and n is 5. The cure sites or functional groups X¹ noted herein, e.g., nitrogen-containing groups, include the reactive sites for crosslinking when reacted with a curative. Compounds according to formula (A) may be used alone or in various, optional, combinations thereof. From a crosslinking perspective, it is preferred that the crosslinking functional group is a nitrogen-containing group, preferably a nitrile group.

Further examples of cure site monomers according to formula (A) include formulas (1) through (17) below:

CY₂═CY(CF₂)ₙ—X² (1)

wherein Y is H or F, n is an integer from 1 to about 8

CF₂═CFCF₂Rf²—X² (2)

wherein Rf² is (—CF₂)ₙ—, —(OCF₂)ₙ— and n is 0 or an integer from 1 to about 5

CF₂═CFCF₂(OCF(CF₃)CF₂)ₘ(OCH₂CF₂CF₂)ₙOCH₂CF₂—X² (3)

wherein m is 0 or an integer from 1 to about 5 and n is 0 or an integer of from 1 to about 5

CF₂═CFCF₂(OCH₂CF₂CF₂)ₘ(OCF(CF₃)CF₂)ₙOCF(CF₂)—X² (4)

wherein m is 0 or an integer from 1 to about 5, and n is 0 or an integer of from 1 to about 5

CF₂═CF(OCF₂CF(CF₃))ₘO(CF₂)ₙ—X² (5)

wherein m is 0 or an integer from 1 to about 5, and n is an integer of from 1 to about 8

CF₂═CF(OCF₂CF(CF₃))ₘ—X² (6)

wherein m is an integer from 1 to about 5

CF₂═CFOCF₂(CF(CF₃)OCF₂)ₙCF(—X²)CF₃ (7)

wherein n is an integer from 1 to about 4

CF₂═CFO(CF₂)ₙOCF(CF₃)—X² (8)

wherein n is an integer of from 2 to about 5

CF₂═CFO(CF₂)ₙ—(C₆H₄)—X² (9)

wherein n is an integer from 1 to about 6

CF₂═CF(OCF₂CF(CF₃))ₙOCF₂CF(CF₃)—X² (10)

wherein n is an integer from 1 to about 2

CH₂═CFCF₂O(CF(CF₃)CF₂O)ₙCF(CF₃)—X² (11)

wherein n is 0 or an integer from 1 to about 5

CF₂═CFO(CF₂CF(CF₃)O)ₘ(CF₂)ₙ═X² (12)

wherein m is 0 or an integer from 1 to about 4 and n is an integer of 1 to about 5

CH₂═CFCF₂OCF(CF₃)OCF(CF₃)—X² (13)

CH₂═CFCF₂OCH₂CF₂—X² (14)

CF₂═CFO(CF₂CF(CF₃)O)ₘCF₂CF(CF₃)—X² (15)

wherein m is an integer greater than 0

CF₂═CFOCF(CF₃)CF₂O(CF₂)ₙ—X² (16)

wherein n is an integer that is at least 1

CF₂═CFOCF₂OCF₂CF(CF₃))OCF₂—X² (17)

wherein X² can be a monomer reactive site subunit such as a nitrile (—CN), carboxyl (—COOH), an alkoxycarbonyl group (—COOR⁵, wherein R⁵ is an alkyl group of 1 to about 10 carbon atoms which may be fluorinated or perfluorinated), a halogen or alkylated halogen group (I or Br, CH₂I and the like). It is preferred that perfluorinated compounds when used as cure site monomers have no hydrogen atoms in that portion of the backbone of the cure site monomer that will lie in the polymer backbone chain. Such cure site monomers are used if excellent heat resistance is desired for the perfluoroelastomer resulting from curing the perfluoropolymers as well as for preventing decrease in molecular weight due to chain transfer when synthesizing the perfluoroelastomer by polymerization reaction. Further, compounds having a CF₂═CFO-structure are preferred from the viewpoint of providing excellent polymerization reactivity with TFE.

Suitable cure site monomers preferably include those having nitrogen-containing cure sites such as nitrile or cyano cure sites, for preferred crosslinking reactivity. However, cure sites (having multiple and varied backbones in addition to those noted above) and having carboxyl, alkoxycarbonyls, COOH and other similar cure sites known in the art and to be developed may also be used. The cure site monomers may be used alone or in varied combinations.

Preferred perfluoropolymers that may be used herein include TFE in a molar percentage of TFE in the perfluoropolymer compound of about 50 about 95 mole percent. Such a pefluoropolymer may also incorporate a further co-monomer that is preferably also perfluorinated such as a PAVE, many of which are known in the art and may be used herein. A variety of PAVEs may be used in the curable polymer for use in the compositions herein. The cure site monomer in one embodiment may also be a perfluorinated cure site monomer with one more cure site monomers, which may be a cyano group(s). In one embodiment, there may be two such cure site groups, such as one cure site with a primary cyano cure site group and one with a secondary cyano cure site group.

Suitable perfluoropolymers are commercially available from Daikin Industries, Ltd. and are described in U.S. Pat. Nos. 6,518,366 and 6,878,778 and U.S. Published Patent Application No. 2008-0287627, which are each incorporated herein in relevant part with respect to the perfluoropolymers described therein. Additional commercially available perfluoropolymers for use in preferred embodiments herein including at least two cure site monomers are those available from Federal State Unitary Enterprise S.V. Lebedev Institute of Synthetic Rubber of Petersburg, Russia or Lodestar in the United States as described within the scope of International Publication No. WO 00/29479 A1, incorporated herein in relevant part with respect to such perfluoroelastomers, as well as commercial perfluoroelastomers available from Federal State Unitary Enterprise S.V. Lebedev Institute of Synthetic Rubber as PFK-65 or PFK-100.

In some embodiments herein, a curable perfluoropolymer may be used having a TFE content ranging from about 40 to about 80 mole percent; a PAVE content ranging from about 20 to about 60, and wherein each of the cure site monomers may be present in an amount of from about 0.1 mole percent to about 10 mole percent total, or each is present in an amount of about 0.1 to about 6 mole percent, or in a further preferred embodiment in which a first cure site monomer is present in an amount of about 0.2 to about 2.0 mole percent and a second cure site monomer is present in an amount of about 0.5 to about 5.0 mole percent.

In some embodiments, there are two curable fluoropolymers in a blend in which a polymer such as that noted above may be used with a second curable fluoropolymer or curable perfluoropolymer used herein that may be the same or different than that noted above, and such second curable polymer may have, but need not have, the same content of TFE or PAVE. Preferably a second perfluoropolymer may be used and can be one in which a fluoroplastic material is incorporated therein such as a fluoroplastic. The fluoroplastic particles may be provided in a variety of forms and using a variety of techniques. Fluoroplastics such as PTFE, and co-polymers thereof (FEP and PFA type polymers), core-shell or other modified fluoropolymers and in a variety of sizes (microparticles, nanoparticles and the like), each of which alone or in combination may be incorporated into the material by mechanical means or chemical processing and/or polymerization. Techniques which are known or to be developed may be employed, such as those described in U.S. Pat. Nos. 4,713,418 and 7,476,711 (each of which is incorporated herein by reference with respect to such technology) and other techniques as described in U.S. Pat. No. 7,019,083, also incorporated herein by reference with respect to use of fluoroplastic particles. Suitable commercially available polymers are commercially available from 3M Corporation of St. Paul, Minn.

Examples of other perfluoropolymers and resulting elastomers formed therefrom using cure site monomers such as those noted above may be also be found in U.S. Pat. Nos. 6,518,366, 6,878,778 and U.S. Published Patent Application No. 2008-0287627 as well as U.S. Pat. No. 7,019,083, each is incorporated herein in relevant part with respect to the perfluoropolymers described therein and their resulting elastomers and methods of forming the same.

Perfluoropolymers for use in the compositions claimed herein may be synthesized using any known or to be developed polymerization technique for forming fluorine-containing elastomers using polymerization, including, for example, emulsion polymerization, latex polymerization, chain-initiated polymerization, batch polymerization and others. Preferably, the polymerization is undertaken so that reactive cure sites are located either on either or both terminal ends of the polymer backbone and/or are depending from the main polymer backbone.

Uncured perfluoropolymers are commercially available, including perfluoropolymers sold under the name Dyneon™ by 3M Corporation, St. Paul, Minn., Daiel-Perfluor® and other similar polymers, available from Daikin Industries, Ltd. of Osaka, Japan. Other preferred materials are available also from Solvay Solexis in Italy, Federal State Unitary Enterprise S.V. Lebedev Institute of Synthetic Rubber of Petersburg, Russia, Asahi Glass, Japan, and W.L. Gore. Other examples of suitable perfluoropolymers and blends thereof may be found, for example in U.S. Pat. Nos. 9,018,309 and 9,365,712, incorporated herein by reference with respect to suitable perfluoropolymers, and blends thereof.

While the uncured perfluoropolymers may be cured through any method, including use of radiation curing, it is preferred to include at least one curative (also referred to herein as crosslinking agents, curing agents and/or curing systems) for use with various curable fluorine-containing elastomer and perfluoroelastomer compositions herein may be selected for use with various cure sites described herein and should be capable of curing (i.e., capable of reacting and crosslinking) or otherwise undergoing a curing reaction with the cure sites or functional groups of the cure site monomer(s) of the various uncured perfluoropolymers in the compositions to form crosslinks, resulting in an elastomeric material in the form of a molded article.

Preferred crosslinking or curing agents are those that form crosslinks that have oxazole, thiazole, imidazole, or a triazine rings. Such compounds as well as other curatives including amidoximes, tetraamines and amidrazones may be used for cross-linking in the present invention.

For nitrogen-containing cure sites, preferred curatives are bisphenyl-based curatives and derivatives thereof, including bisaminophenol and its salts and combinations thereof; bisaminothiphenols, parabenzoquinone dioxime (PBQD), as well as salts of various such compounds may be used. Examples of suitable curatives may be found, for example, in U.S. Pat. Nos. 7,521,510 B2, 7,247,749 B2 and 7,514,506 B2, each of which is incorporated herein in relevant part with respect to the listing of various curatives for cyano-group containing perfluoropolymers. In addition, the perfluoropolymers may be cured using radiation-curing technology.

Further preferred curatives for cure sites having a cyano-group cure site are curatives having aromatic amines with at least two crosslinkable groups as in formulas (I) and (II) below, or a combination thereof, which form benzimidazole cross-linking structures upon cure. These curatives are known in the art and discussed in relevant part and with specific examples in U.S. Pat. Nos. 6,878,778 and 6,855,774, which are incorporated herein in their entirety.

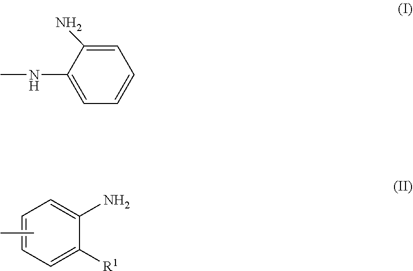

wherein R¹ is the same or different in each group according to formula (II) and may be NH₂, NHR², OH, SH or a monovalent organic group or other organic group such as alkyl, alkoxy, aryl, aryloxy, aralkyl and aralkyloxy of from about 1 to about 10 carbon atoms, wherein the non-aryl type groups may be branched or straight chain and substituted or unsubstituted and R² may be —NH₂, —OH, —SH or a monovalent or other organic group such as an aliphatic hydrocarbon group, a phenyl group and a benzyl group, or alkyl, alkoxy, aryl, aryloxy, aralkyl and aralkyloxy groups, wherein each group is from about 1 to about 10 carbon atoms, wherein the non-aryl type groups may be branched or straight chain and substituted or unsubstituted. Preferred monovalent or other organic groups, such as alkyl and alkoxy (or perfluorinated versions thereof) are from 1 to 6 carbon atoms, and preferred aryl type groups are phenyl and benzyl groups. Examples thereof include —CF₃, —CH₂F, —CH₂CF₃ or —CH₂C₂F₅, a phenyl group, a benzyl group; or a phenyl or benzyl group wherein 1 to about 5 of the hydrogen atoms are substituted by fluorine atoms such as —C₆F₅, —CH₂C₆F₅, wherein groups may be further substituted, including with —CF₃ or other lower perfluoroalkyl groups, or, phenyl or benzyl groups in which 1 to 5 hydrogen atoms are substituted by CF₃ such as for example C₆H₅₋ₙ(CF₃)ₙ, —CH₂C₆H₅₋ₙ(CF₃)ₙ (wherein n is from 1 to about 5). Hydrogen atoms may be further substituted with phenyl or benzyl groups. However, a phenyl group and CH₃ are preferred as providing superior heat resistance, good cross-linking reactivity and relatively easy synthesis.

A structure having formula (I) or (II) incorporated in an organic amine should include at least two such groups of formula (I) or (II) such that at least two cross-linking reactive groups are provided.

Also useful herein are curatives having formulas (III), (IV) and (V) shown below.

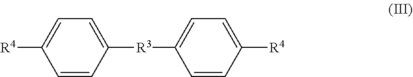

wherein R³ is preferably SO, O or CO or an organic or alkylene type group, such as an alkyl, alkoxy, aryl, aralkyl or aralkoxy group of from one to six carbon atoms or perfluorinated versions of such groups, having from about one to about 10 carbon atoms, and being branched or straight chain, saturated or unsaturated, and branched or straight chain (with respect to the non-aryl type groups) or a single bond. R⁴ is preferably a reactive side group such as those set forth below:

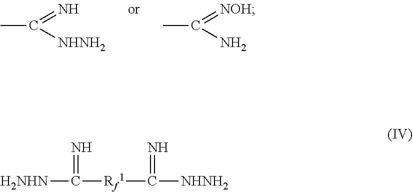

wherein Rf¹ is a perfluoroalkyl or perfluoroalkoxy group of from about 1 to about 10 carbon atoms that may be a straight or branched chain group and/or saturated or unsaturated and/or substituted or unsubstituted; and

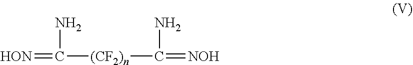

wherein n is an integer of about 1 to about 10.

Single curatives or combinations thereof may be chosen from all of the curatives herein within the scope of the invention depending on the cure sites to be crosslinked. With respect to heat resistance, oxazole-, imidazole-, thiazole- and triazine-ring forming crosslinking agents are preferred and can include the formula compounds listed below and discussed further below with respect to Formulae (I), (II), (III), (IV) and (V), specifically, formula (II) wherein R¹ is the same or different and each is —NH₂, —NHR², —OH or —SH, wherein R² is a monovalent organic group, preferably not hydrogen; formula (III) wherein R³ is —SO₂—, —O—, —CO—, and alkylene group of 1 to about 6 carbon atoms, a perfluoroalkylene group of 1 to about 10 carbon atoms or a single bond and R⁴ is as noted below; formula (IV) wherein Rf¹ is a perfluoroalkylene group of 1 to about 10 carbon atoms, and formula (V) wherein n is an integer of 1 to about 10. Of such compounds, those of formula (II) as noted herein are preferred for heat resistance, which is enhanced due to stabilization of the aromatic rings after crosslinking. With respect to R¹ in the formula (II), it is preferred also to use —NHR² as R¹, since an N—R² bond (wherein R² is a monovalent organic group and not hydrogen) is higher in oxidation resistance than an N—H bond,

Compounds having at least two groups as in formula (II) are preferred and having 2 to 3 crosslinkable reactive groups thereon, more preferably having 2 crosslinkable groups.

Exemplary curatives based on the above preferred formulae include at least two functional groups, such as the following structures formula (VI), (VII) or (VIII):

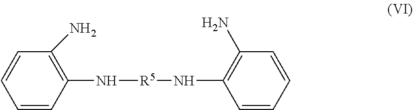

wherein R⁵ represents a saturated or unsaturated, branched or straight chain, substituted or unsubstituted group such as alkyl, alkoxy, aryl, SO, O, CO, or similar groups which are perfluorinated with respect to the carbon atoms and which is preferably about 1 to about 10 carbon atoms;

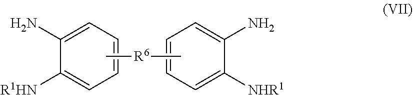

wherein R¹ is as defined elsewhere herein and R⁶ may be O, SO₂, CO or an organic group which may be perfluorinated, such as alkyl, alkoxy, aryl, aryloxy, aralkyl and aralkyloxy of from about 1 to about 10 carbon atoms, wherein the non-aryl type groups may be branched or straight chain and substituted or unsubstituted, or a single or alkylene bond.

From the view of easy synthesis, in a further embodiment preferred herein, the most preferred crosslinking agents are compounds having two crosslinkable reactive groups as represented by formula (II) are shown below in formula (VIII).

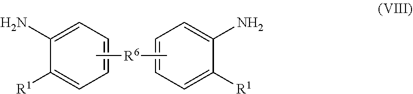

wherein R as above and R⁶ is —SO₂, —O—, —CO—, an alkylene group of 1 to about 6 carbon atoms, a perfluoroalkylene group of 1 to about 10 carbon atoms, a single bond or a group as shown in Formula (IX):

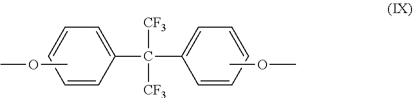

wherein this formula provides an easier synthesis. Preferred examples of alkylene groups of from 1 to about 6 carbon atoms are methylene, ethylene, propylene, butylene, pentylene, hexylene and the like. Examples of perfluoroalkylene groups of 1 to about 10 carbon atoms are

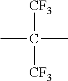

and the like. These compounds are known as examples of bisaminophenyl compounds. Preferred compounds according to this structure include those of formula (X):

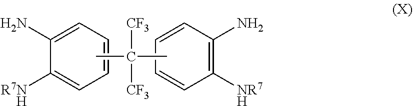

wherein R⁷ the same or different in each instance and each s hydrogen, an alkyl group of 1 to about 10 carbon atoms; a partially fluorinated or perfluorinated alkyl group of 1 to 10 carbon atoms; a phenyl group; a benzyl group; or a phenyl or benzyl group in which 1 to about 5 hydrogen atoms have been replaced by fluorine or a lower alkyl or perfluoroalkyl group such as CF₃.

Non-limited examples of curatives include 2,2-bis(2,4-diaminophenylhexafluoropropane, 2,2-bis[3-amino-4-(N-methylamino)phenyl] hexafluoropropane, 2,2-bis[3-amino-4-(N-ethylamino)phenyl] hexafluoropropane, 2,2-bis[3-amino-4-(N-propylamino)phenyl] hexafluoropropane, 2,2-bis[3-amino-4-(N-phenylamino)phenyl]hexafluoropropane, 2,2-bis[3-amino-4-(N-perfluorophenylamino)phenyl]hexafluoropropane, 2,2-bis[3-amino-4(N-benzylamino)phenyl]hexafluoropropane, and similar compounds. Of these, for preferred excellent heat resistance properties, 2,2-bis[3-amino-4(N-methylamino)phenyl]hexafluoropropane, 2,2-bis[3-amino-4-(N-ethylamino)phenyl]hexafluoropropane, 2,2-bis[3-amino-4-(N-propylamino)phenyl]hexafluoropropane and 2,2-bis[3-amino-4-(N-phenylamino)phenyl]hexafluoropropane are preferred. Also preferred for heat resistant properties is tetra-amines such as 4,4′-[2,2,2-Trifluoro-1-(trifluoromethyl) ethylidene]bis[N1-phenyl-1,2-benzenediamine] or 2,2-bis[3-amino-4-(N-phenylaminophenyl)]hexafluoropropane is preferred.

Other suitable curatives include oxazole-, imidazole-, thiazole-, and triazine-ring forming curatives, amidoxime and amidrazone crosslinking agents, and particularly bisaminophenol, bisaminophenol AF, and combinations thereof; bisaminothiophenols; bisamidines; bisamidoximes; bisamidrazones; monoamidines; monoamidoximes and monoamidrazones as known in the art or to be developed, examples of which are set forth, for example in U.S. Pat. Nos. 7,247,749 and 7,521,510, incorporated herein in relevant part by reference, including the curatives and co-curatives and accelerators therein. The bisamidoxime, bisamidrazone, bisaminophenol, bisaminothiophenol or bisdiaminophenyl curatives are most preferred herein for reacting with nitrile or cyano groups, carboxyl groups, and/or alkoxycarbonyl groups in the perfluoropolymer to form a perfluoroelastomer preferred in some embodiments herein having an oxazole ring, a thiazole ring, an imidazole ring, or a triazine ring as crosslinks in the resulting cured articles formed from the compositions herein.

In one embodiment herein, a compound can be used including at least two chemical groups with cross-linking reactive groups as in Formula (I) or (II) in order to increase heat resistance and to stabilize an aromatic ring system. For groups such as in (I) or (II), having two to three such groups, it is preferred to have at least two in each group (I) or (II), as having a lesser number of groups may not provide adequate cross-linking. Such combinations are known and are described in applicant's U.S. Pat. Nos. 9,018,309 B2 and 9,365,712 B2, incorporated herein in relevant part.

Such compositions preferably are blends having the first curable perfluoropolymer and the second curable perfluoropolymer in a range of ratios of about 95:5 to about 5:95, preferably about 80:20 to about 20:80, and more preferably about 40:60 to about 60:40, or about 50:50.

Each of the at least one cure site monomers in each of the curable perfluoropolymers is preferably present in an amount of about 0.1 to about 10 mole percent respectively and individually in each of the first curable perfluoropolymer and the second curable perfluoropolymer.

When at least one curative is used, it may be present in varying amounts suitable to cure the curable perfluoropolymers' cure site monomers in the composition, for example, in total amounts of about 0.2 parts by weight to about 10 parts by weight per 100 parts by weight of the perfluoropolymers in the composition, and each may be present in an amount of about 0.1 to about 6 parts by weight per 100 parts by weight of the perfluoropolymers in the composition, or preferably about 0.1 to about 2 parts by weight per 100 parts by weight of the perfluoropolymers in the composition. In one embodiment, at least two curatives are used in the first perfluoropolymer in an amount of about 0.5 to about 4 parts by weight per 100 parts by weight of the perfluoropolymers for a first curative and about 0.3 to about 2 parts by weight per 100 parts by weight of the perfluoropolymers for at least one second curative.

The at one cure site in the at least one cure site monomer in either or both of the first and second curable perfluoropolymers is preferably a nitrogen-containing cure site. The at least one cure site in the at least one cure site monomer in the first curable perfluoropolymer may be selected from the group consisting of cyano, carboxyl, carbonyl, alkoxycarbonyl, and combinations thereof, and most preferably is a cyano group.

The at least one curative may preferably one of the following suitable curatives: fluorinated imidoylamidines; bisaminophenols; bisamidines; bisamidoximes; bisamidrazones; monoamidines; monoamidoximes; monoamidrazones; biasminothiophenols; bisdiaminophenyls; tetra-amines and aromatic amines having at least two crosslinkable groups represented by the formula (II):

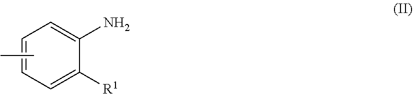

wherein R¹ are the same or different and each is —NH₂, —NHR², —OH or —SH; R² is a monovalent organic group;

compounds represented by the formula (III):

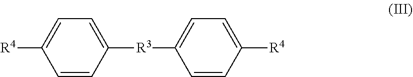

wherein R³ is —SO₂—, —O—, —CO—, an alkylene group having 1 to 6 carbon atoms, a perfluoroalkylene group having 1 to 10 carbon atoms or a single bond and R⁴ is

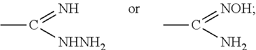

compounds represented by Formula (IV):

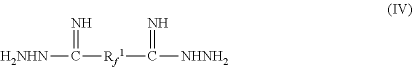

wherein Rf¹ is a perfluoroalkylene group having 1 to 10 carbon atoms; compounds represented by the formula (V):

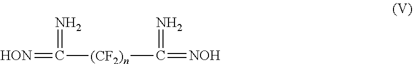

in which n is an integer of 1 to 10; and combinations thereof, wherein the at least one curative is capable of reacting with the least one cure site in the at least one first perfluoropolymer and the at least one cure site in the second perfluoropolymer to crosslink the at least one perfluoropolymer and the at least one second perfluoropolymer in the composition.

The at least one curative is even more preferably an aromatic amine having at least two crosslinkable groups represented by the formula (II), wherein R¹ is —NHR²; fluorinated imidoylamidines; bisaminophenols; and combinations thereof.

In one embodiment, the curable fluorine-containing elastomer composition includes the at least one curative as a compound which is preferably a tetra-amine compound within the scope of those compounds noted above. Such compounds may be used alone or in combination. Most preferred compounds for use herein as curatives are those in accordance with formula (II) wherein R¹ is —NHR² and R² is an aryl group. Such compound is also known as is 4,4′[2,2,2-Trifluoro-1-(trifluoromethyl) ethylidene]bis[N1-phenyl-1,2-benzenediamine] (“Nph-AF”) (Also known as “V6”).

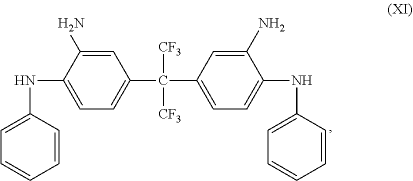 [SMILES: Nc1cc(C(c2ccc(Nc3ccccc3)c(N)c2)(C(F)(F)F)C(F)(F)F)ccc1Nc1ccccc1 ; ","]

In another embodiment herein, a most preferred curative includes perfluoroimidoylamidines such as those found in U.S. Pat. No. 8,362,167, incorporated by reference in relevant part herein, with respect to the following compound and similar compounds. One preferred compound, also described as DPIA-65 is shown hereinbelow.

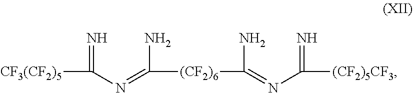

Other preferred compounds are bisaminophenol and its salts, and combinations thereof.

In one further embodiment, the composition is preferably a perfluoroelastomer composition and the at least one curative includes use of Nph-AF (or V6):

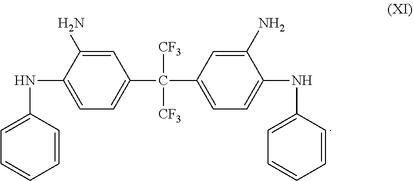 [SMILES: Nc1cc(C(c2ccc(Nc3ccccc3)c(N)c2)(C(F)(F)F)C(F)(F)F)ccc1Nc1ccccc1 ; "."]

This compound may be used alone or with another curative(s), such as in combination with bisaminophenol or bisaminophenol AF and/or in combination with or as an alternative thereto, wherein the at least one curative may further comprise the DPIA-65:

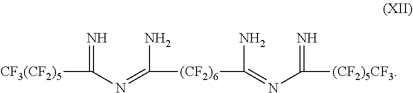

In other preferred embodiments herein, the compound of formula (XII) is used alone or in combination with

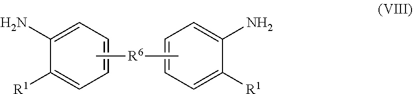

wherein each R¹ is independently —NH₂, —NHR², —OH or —SH; R² is a monovalent organic group; and wherein R⁶ is —SO₂, —O—, —CO—, an alkylene group of 1 to about 6 carbon atoms, a perfluoroalkylene group of 1 to about 10 carbon atoms, a single bond or a group as shown in Formula (IX):

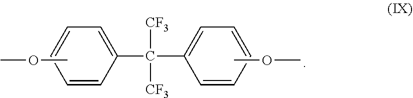

The second curative in such a combination is preferably a compound according to formula (X):

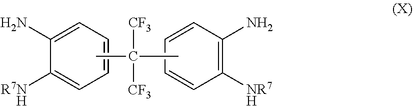

wherein R⁷ is independently selected from hydrogen, an alkyl group of 1 to about 10 carbon atoms; a partially fluorinated or perfluorinated alkyl group of 1 to 10 carbon atoms; a phenyl group; a benzyl group; or a fluorinated or partially fluorinated phenyl group; a fluorinated or partially fluorinated benzyl group; or a phenyl or an alkyl group having a functional group or groups that is a lower alkyl or perfluoroalkyl group. The second curative in the combination is preferably a bisaminophenol and its salts or combinations thereof.

In a preferred embodiment, preferred ratios of the type of curatives represented by formula XII to a bisaminophenol type curative or related compound may preferably be about 0.5:1 to about 35:1, preferably about 1:1 to about 32:1 and most preferably about 2:1 to 15:1.

One preferred curable perfluoroelastomer composition for use with the microdiamond particles noted above includes a first curable perfluoropolymer comprising tetrafluoroethylene, a first perfluoroalkylvinyl ether and at least one first cure site monomer having at least one cure site, or in a further embodiment, having at least two cure site monomers, wherein the tetrafluoroethylene and, a second perfluoroalkylvinyl ether are present in the first curable perfluoropolymer in varied amounts and at least one second cure site monomer having at least one cure site, wherein the second curable perfluoropolymer may incorporate therein an optional fluorinated material or other fillers and the like as noted above, and preferably further includes at least one curative. The microdiamond particles may be incorporated into the polymer blend before or after blending the polymers and before or after incorporating any other fillers or additives, however, it is preferred that when using blended polymers, that the polymers are blended prior to introducing additives or fillers and/or the microdiamond particles. It is also preferred that any curative(s) are introduced after other fillers and additives, including the microdiamond particles, and before curing to avoid premature initiation of curing.

The at least one curative may be selected from the group consisting of:

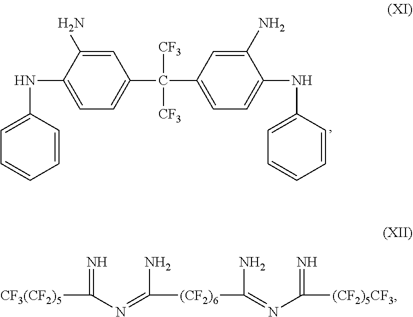

bisaminophenol, bisaminophenol AF, and combinations thereof, including combinations of the formula of (XII) and bisaminophenol and/or its salts.

At least one of the cure site monomers in either of the first or second curable perfluoropolymer preferably includes a nitrile group or other nitrogen-containing cure site such as those noted above.

In addition to the preferred curatives noted herein for use with fluorine-containing curable perfluoropolymers having nitrile groups and the like, it is within the scope of the invention to cure the nitrile groups using curatives known in the art for the first and second perfluoropolymers and/or for other perfluoropolymers added to the compositions herein. Examples of other curatives known in the art that are preferred include those that are able to form triazine rings. Peroxide curatives and co-curatives as are well known in the art may also be used if halogenated cure sites are employed. Other suitable curatives may include those listed above.

Such cured fluoroelastomer and perfluoroelastomer compositions formed from curable fluoroelastomeric or perfluoroelastomeric compositions as noted herein may be cured and shaped so as to form a molded article(s). Generally, the molded articles will be formed as sealing members such as O-rings, seals, gaskets, inserts and the like, but other shapes and uses known or to be developed in the art are contemplated herein.

The molded article may be bonded to a surface for forming, for example, bonded seals. Such bonded seals may be used, for example for forming pre-bonded doors, gates, and slit valve doors for use, e.g., in semiconductor processing and other end use applications. The surfaces to which such molded articles, such as seals may be bonded include polymeric surfaces as well as metal and metal alloy surfaces. In one embodiment, the invention includes a gate or slit valve door formed of, e.g., stainless steel or aluminum, to which an O-ring seal conforming to a recess in the door configured for receiving the seal. The bonding may occur through use of a bonding composition or through an adhesive.

The curable elastomer compositions herein are first prepared by combining the at least one curable fluoro- or perfluoropolymer(s) as described elsewhere herein if a blend is used, e.g., a first and a second perfluoropolymer.

The polymers may be combined using typical rubber processing equipment such as an open roll, Banbury mixer, kneader or the like. The compositions may also be prepared using a method of a closed mixer. Preferably a typical mixer, such as a two-rotor mixer as is typically used for combining fluoropolymer(s) and the other materials noted. Preferably, in this method, particularly for perfluoropolymer(s) the polymers are mixed at room temperatures, or at elevated temperatures of about 30° C. to about 100° C., or about 50 to about 250° C., depending on the mixer type and design.

If desired, and although unnecessary, other additives may also be admixed into the composition, and may be added along with addition of the microdiamond particles. The microdiamond particles may be incorporated at any point, but if a polymer blend is formed, may be added after blending. Other additives are not required, but may be added if desired to alter certain properties. Examples of such additives include cure accelerators, co-curatives, co-agents, processing aids, plasticizers, fillers such as silica, fluoropolymers as noted above such as TFE, fluorinated-copolymers, core-shell modified fluoropolymers, and the like in micropowder, pellet, fiber and nanopowder forms, fluorographite, silica, barium sulfate, carbon, carbon black, carbon fluoride, clay, talc, metallic fillers (titanium oxide, aluminum oxide, yttrium oxide, silicon oxide, zirconium oxide), metal carbides (silicon carbide, aluminum carbide), metallic nitrides (silicon nitride, aluminum nitride), other inorganic fillers (aluminum fluoride, carbon fluoride), colorants, organic dyes and/or pigments, such as azo, isoindolenone, quinacridone, diketopyrrolopyrrole, anthraquinone, and the like, imide fillers (such as polyimide, polyamide-imide and polyetherimide), ketone plastics (such as polyarylene ketones like PEEK, PEK and PEKK), polyarylates, polysulfones, polyethersulfones, polyphenylene sulfides, polyoxybenzoate, and the like may be used in amounts known in the art and/or which may be varied for different properties. All of the fillers herein may be used alone or in combinations of two or more such fillers and additives.

Preferably any additives which are within the at least one optional curative(s) capable of curing the cure site(s) on the at least one first and/or second cure site monomers, including any cure accelerators, co-curatives, co-agents and the like are added after other fillers, additives and/or the microdiamond particles are incorporated into the fluoro- or perfluoropolymer(s).

The compositions herein may be highly filled if desired or formed without fillers. Optional, additional fillers such as those noted above may be used in a total amount of up to about 100 parts to about 150 parts per 100 parts of the combined curable perfluoropolymers in the composition, and may be more or less, particularly if higher levels of the microdiamond component are contemplated.

After the curable fluoro- or perfluoropolymer(s) are combined with the microdiamond and/or any other optional additive(s), including any optional curative(s), the curable fluoro- or perfluoropolymer(s) in the elastomeric or perfluoroelastomeric compositions are cured to form a cured fluoroelastomeric or perfluoroelastomeric compositions as described herein.

The curable compositions are preferably cured at temperatures and for times which would be traditionally used to form the desired cross-links depending on the curing method or curing system, cure sites and/or curatives chosen. The temperatures should be sufficient to allow the curing reaction to proceed until the curable fluoro- or perfluoropolymer(s) in the composition are substantially cured, preferably at least 90% cured or higher. Preferred curing temperatures and times for preferred curable perfluoropolymer compositions, e.g., are about 150° C. to about 250° C., for about 5 to about 40 minutes. Following curing, optional postcuring steps may be used. Acceptable postcure temperatures and times for most preferred perfluoropolymers noted herein, e.g., are about 200° C. to about 320° C. for about 5 to about 48 hours.

While curing, the curable compositions described herein may be formed into a molded article while simultaneously curing using heat and pressure applied to a mold. Preferably, the combined curable fluoro- and perfluoropolymer(s) are formed into a preform, such as an extruded rope or other shape useful for including the preform in a mold having a recess shaped to receive the preform and for forming a molded article while curing. Optional postcuring and bake out can also be carried out preferably under air or nitrogen or vacuum.

Additional curatives and cure accelerators, either to work with or accelerate the cure of the fluoro- or perfluoropolymer(s) or to cure and/or accelerate cure of any additional optional curable polymers may also be included herein. Non-curable fluoropolymers or perfluoropolymers include those which lack a reactive cure site and are formed from one or more ethylenically unsaturated monomers (such as TFE, HFP and PAVE). Additional curable perfluoropolymers may be any of the curable perfluoropolymers noted herein as well as those having cure sites suitable for crosslinking with organic peroxide cure systems as are known in the art, bisaminophenyl-based cures and the like. Such polymers may be added to develop alternative blends and to modify the properties of the compositions noted herein.

The invention also includes methods for forming a fluoroelastomeric article with reduced particulation, reduced compression set particularly at high temperatures and/or with reduced sticking force which preferably also have enhanced plasma resistance in fluorine-based plasma, oxygen-based plasma, hydrogen-based plasma, and combinations of such plasmas and improved physical properties. The methods include forming the fluoroelastomeric article by preparing a curable fluorine-containing elastomer compositions such as those described in detail above that have at least one first curable fluoropolymer or perfluoropolymer, including at least one fluorinated monomer, such as VF2 or HFP for a fluoropolymer alone or tetrafluoroethylene, or for a perfluoropolymer, TFE and other similar perfluorinated olefins and a perfluoroalkylvinyl ether, each having at least one fluorine-containing cure site monomer (if relying on a cure site other than the groups on the VF2), and each such cure site monomer comprising at least one cure site. Such compositions may also optionally include at least one curative. The method further includes adding into the curable fluorine-containing elastomer composition microdiamond particles having an average particle size of greater than 0.1 microns to about 100 microns or other suitable particle sizes as described above and in amounts as noted above, and then curing the curable fluorine-containing elastomer composition to form the fluoroelastomeric article.

In one embodiment, the curable fluorine-containing elastomer composition may include at least one additional additive/filler, e.g., carbon black or those mentioned above, and the method may further comprise adding the microdiamond particles into the fluorine-containing elastomer composition while adding the at least one additive to the curable fluoro- or perfluoropolymer(s). Although it will be understood from this disclosure that the microdiamond particle(s) may be added prior to addition of any optional filler(s) or additive(s) as noted above. If one or more curative(s) are used, they are preferably incorporated after the other additives and/or microdiamond particles are incorporated into the fluoro- or perfluoropolymer(s).

In an embodiment of the method, the composition is cured to form the fluoroelastomeric article, which has reduced particulation in comparison to a second similar fluoroelastomeric article which is formed using the same fluorine-containing elastomer composition but without microdiamond particle when each of the fluoroelastomeric article and the second fluoroelastomeric article are exposed to a fluorine- and/or oxygen- and/or hydrogen-based plasma or combinations of these plasmas. Such low particulation is achieved unexpectedly in comparison with existing commercial products which are sold as plasma-resistant. As noted above and in all methods herein, the fluoroelastomeric article may be a perfluoroelastomeric article.

In the method, it is also preferred that the compression set value of the fluoroelastomeric article at 250° C./70 hours/25% deflection, and preferably also the compression set value of the fluoroelastomeric article at 350° C./70 hours/18% deflection, is reduced in comparison to the second fluoroelastomeric article, including in the instance when the second fluoroelastomeric article is formed with a traditional filler such as a carbon black filler.

It is also preferred that the fluoroelastomeric article has a reduced sticking force in comparison to the second fluoroelastomeric article, including when traditional filler is added to the second fluoroelastomeric article. It is also preferred that the fluoroelastomeric article with low particulation from the method has improved plasma resistance to fluorine-based plasma, oxygen-based plasma, hydrogen-based plasma, and combinations of these plasmas, and improved physical properties in comparison to the second fluoroelastomeric article.

In one of the methods herein, a fluoroelastomeric article is formed having reduced compression set by preparing a curable fluorine-containing elastomer composition that has at least one first curable fluoropolymer that includes at least one fluorinated monomer, and at least one fluorine-containing cure site monomer that includes at least one cure site. The composition may also include at least one curative as described in detail above. Added into the curable fluorine-containing elastomer composition are microdiamond particles having an average particle size of greater than 0.10 microns to 100 microns. The fluorine-containing elastomer composition is cured to form the fluoroelastomeric article, which preferably has a compression set value at 250° C./70 hours/25% deflection that is reduced in comparison to a second fluoroelastomeric article formed of the same curable fluorine-containing elastomer composition, but that does not include the microdiamond particles, and which preferably also has a compression set value of the fluoroelastomeric article at 350° C./70 hours/18% deflection is also reduced in comparison to the second fluoroelastomeric article, and that such benefit is further achieved even if a traditional filler such as carbon black is incorporated therein. Such high temperature compression set values are indicative of the ability to use the inventive compositions in end applications having high service temperatures of over about 200° C., or over above 300° C. or over above 350° C.

It is preferred that the fluoroelastomeric article also has reduced particulation in comparison to the second fluoroelastomeric article when the fluoroelastomeric article and the second fluoroelastomeric article are exposed to fluorine-based plasma, oxygen-based plasma, hydrogen-based plasma, and combinations thereof, including in the instance when a traditional filler such as carbon black is incorporated in the second fluoroelastomeric article. It is further prepared that the fluoroelastomeric article formed has a reduced sticking force in comparison to the second fluoroelastomeric article, an improved resistance to fluorine-based plasma, oxygen-based plasma, hydrogen-based plasma, and combinations thereof, in comparison to the second fluoroelastomeric article, and improved physical properties in comparison to the second fluoroelastomeric article, and in each case these properties are benefited even if a traditional filler is incorporated.

In another method herein a fluoroelastomeric article is formed having a reduced sticking force, so as to avoid situations where a seal in replacement cannot be easily removed from a part, which can required use of tools that damage the parts and creation of particles in the system as well as lost production time and worker costs. By reducing the sticking force economic and production benefits are achieved. In this method, a curable fluorine-containing elastomer composition is prepared including at least one first curable fluoropolymer including at least one fluorinated monomer, and at least one fluorine-containing cure site monomer that as at least one cure site. At least one curative may also be incorporated prior to curing as described above. Microdiamond particles are added into the curable fluorine-containing elastomer composition that have an average particle size of greater than 0.10 microns to 100 microns. The curable fluorine-containing elastomer composition is cured to form the fluoroelastomeric article, wherein the fluoroelastomeric article has a sticking force that is reduced in comparison to a second fluoroelastomeric article formed of the same curable fluorine-containing elastomer composition as the curable fluorine-containing elastomer, but that does not include the microdiamond particles.

It is preferred in this method that the fluoroelastomeric article also has a compression set value at 250° C./70 hours/25% deflection that is reduced in comparison to the second fluoroelastomeric article, and preferably also a compression set value of the fluoroelastomeric article at 350° C./70 hours/18% deflection is reduced in comparison to the second fluoroelastomeric article, each including the situation when the second fluoroelastomeric article also includes a traditional filler such as carbon black. Preferably also, in the method the fluoroelastomeric article has reduced particulation in comparison to the second fluoroelastomeric article when the fluoroelastomeric article and the second fluoroelastomeric article are exposed to fluorine-based plasma, oxygen-based plasma, hydrogen-based plasma, and combinations thereof, improved resistance to fluorine-based plasma, oxygen-based plasma, hydrogen-based plasma, and combinations thereof in comparison to the second fluoroelastomeric article, and improved physical properties in comparison to the second fluoroelastomeric article, and in each instance this benefit occurs including in compositions in which a traditional filler is incorporated.

The invention will now be described below in conjunction with the following, non-limiting examples.

### EXAMPLES

In the following Examples various components are used to evaluate the impact of varying types and amounts of microdiamond in perfluoroelastomer compositions as such materials are known to lack the strength of other elastomers and are most likely to be subjected to harsh environments in clean conditions such as semiconductor applications. Thus, to be able to provide good physical and elastomeric properties that further withstand harsh materials including fluorine- and/or oxygen- and/or hydrogen-based plasma, such as NF₃ and/or O₂ and/or H plasmas and preferably also provide a low sticking force, in such materials demonstrates that similar results could be achieved with low particulation in other less demanding applications.

### Example 1

In a first Example herein, inventive compositions were tested in the same environment as certain competitive products currently sold for use in such plasma environments. A prior FFKM product of applicant herein (Comparative Product A) which does not include microdiamond, but instead uses a polymeric filler, was employed for comparison purposes as was a product by Daikin Industries, Ltd., known as Dupra® DU-3R1 (Comparative Product B) and a product by E.I. DuPont de Nemours, known as Kalrez® 9100 (Comparative Product C). The precise compositions of the competitive commercial products are not known.

Inventive compositions were made using base perfluoropolymer(s) and a curative, with varying levels of microdiamond (Examples 1 and 2). In all Examples herein, the compositions are presented in parts per hundred per 100 parts by weight of the base polymer (unless a separate base polymer weight is given).

In the Examples 1 and 2, curable perfluoropolymers were used from Daikin Industries, Ltd. available as GA-500PR (Polymer A), from 3M Corporation, St. Paul Minn., available as Dyneon® PFE—133 TB Z (Polymer B) and from Lodestar in the United States for Federal State Unitary Enterprise S.V. Lebedev Institute of Synthetic Rubber of Petersburg, Russia known as PFK-100 (Polymer C). Curatives used in these examples included an imidoyl-based curative, DPIA-65, from Federal State Unitary Enterprise S.V. Lebedev Institute of Synthetic Rubber, Petersburg, Russia having the structure shown below:

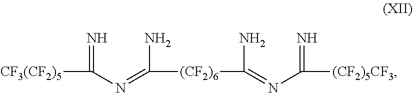

bisaminophenol (BOAP) and 4,4′[2,2,2-Trifluoro-1-(trifluoromethyl) ethylidene]bis[N1-phenyl-1,2-benzenediamine] (Nph-AF).

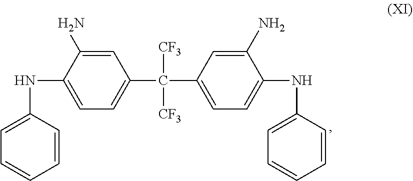 [SMILES: Nc1cc(C(c2ccc(Nc3ccccc3)c(N)c2)(C(F)(F)F)C(F)(F)F)ccc1Nc1ccccc1 ; ","]

Such polymers are described in polymer blends in U.S. Pat. Nos. 9,018,309 and 9,365,712, incorporated herein by reference with respect to such polymers and forming of blend.

A comparative example using the same base polymer but no microdiamond (Comparative Example D) was also prepared as an unfilled composition is typically expected to have the least particulation in a harsh environment (although the physical properties may or may not be adequate depending on the unfilled composition).

The specific formulations known are shown below in Table A. The compositions were each subjected to the same test procedure in which O-rings of similar size (214) were subjected to a standardized plasma exposure test. A clean gas stream flowed past each of the parts during cycling (60,000 cycles) and into a particle detector to determine particle count and sizes.

TABLE A

| | Comp. | Comp. | Example | Example | Comp. | Comp. |
|---|---|---|---|---|---|---|
| Component | Product A | Example D | 1 | 2 | Product B | Prod. C |
| Polymer A | 50 | | | | Unknown | Unknown |
| Polymer B | 50 | 50 | 50 | 50 | | |
| Polymer C | | 50 | 50 | 50 | | |
| Nph-AF | 1.6 | | | | | |
| DPIA-65 | | 4.0 | 3.0 | 3.0 | | |
| Bisaminophenol | | | 0.5 | 0.5 | | |
| Polymer filler | | 1.0 | | | | |
| Fomblin M60 | | 0.75 | 0.25 | 0.25 | | |
| Microdiamond | | | 10 | 5.0 | | |
| (size 0.2 micron) | | | | | | |
| Particles | 6,354,363 | 837,884 | 299,186 | 178,217 | 933,932 | 15,764,725 |
| Generated | | | | | | |

The particles measured in the test method ranged between 0.3 and 10 microns in size. Samples that were not exposed generated almost no particles as would be expected. The samples were then exposed to cycling NF₃ plasma in a test puck formed from aluminum. After exposure and cycling, the particle sizes and counts were processed as collected throughout cycling.

It was found that the plasma exposure during testing created process-induced damage that is exacerbated by the heated cycling. During the testing it was found that the prior Comparative Products A and C had the highest particle counts, while the inventive Examples 1 and 2 had the least particles generated.

### Example 2

Further testing was carried out to evaluate the impact on compression set of a carbon black filler known for use in compounding elastomer compositions for making seals and the like, thermal carbon black N990 in comparison with various loadings of microdiamond. The microdiamond used was from Eastwind Diamond Abrasives. This microdiamond was also used in all of the following Examples unless otherwise noted.

A composition was made using the same base formulation and varying the contents. In this Example, two base curable perfluoropolymers were employed, Polymer C from Example 1 and Polymer B from Example 1. The composition components and varying amounts of carbon black or microdiamond additives are shown below in Table B, where the Inventive Examples 3-9 include either microdiamond only (i.e., Example 8 and 9) or microdiamond along with N990 (i.e., Examples 3-7), with varying amounts of each, and where Comparative Examples G-J included no microdiamond filler, and included only varying amounts of N990.

The data shows that even minor amounts of microdiamond significantly reduce the level of compression set at 250° C. and 350° C. in comparison with those compositions having solely carbon N990. The unexpected benefit of reduction in compression set was not expected when adding a carbon-based filler such as microdiamond, as carbon fillers are known to increase compression set. Further, it can be seen that there is the unexpected benefit of reduction in sticking force when the microdiamond is incorporated. Thus, the compositions herein not only provide a basis for high temperature use, and weight loss reduction in the presence of NF₃, O₂ and/or H plasma, while allowing for good physical properties, but they also provide the unexpected benefit of maintaining or significantly reducing the compression set properties at 250° C. and/or at 350° C. and of reducing the sticking force of the elastomer composition into which they are incorporate.

TABLE B

| | | | | | | | | Comp. | Comp. | Comp. | Comp. |
|---|---|---|---|---|---|---|---|---|---|---|---|
| INGREDIENTS | Ex. 3 | Ex. 4 | Ex. 5 | Ex. 6 | Ex. 7 | Ex. 8 | Ex. 9 | Ex. G | Ex. H | Ex. I | Ex. J |
| Polymer C | 50 | 50 | 50 | 50 | 50 | 50 | 50 | 50 | 50 | 50 | 50 |
| Polymer B | 50 | 50 | 50 | 50 | 50 | 50 | 50 | 50 | 50 | 50 | 50 |
| DPIA-65 | 3 | 3 | 3 | 3 | 3 | 3 | 3 | 3 | 3 | 3 | 3 |
| BOAP | 0.5 | 0.5 | 0.5 | 0.5 | 0.5 | 0.5 | 0.5 | 0.5 | 0.5 | 0.5 | 0.5 |
| Fomblin M-60 | 0.75 | 0.75 | 0.75 | 0.75 | 0.75 | 0.75 | 0.25 | 0.75 | 0.75 | 0.75 | 0.75 |
| Carbon Black N-990 | 5 | 15 | 10 | 5 | 15 | — | — | 25 | 20 | 15 | 10 |
| Microdiamond 0.25 μ | 0.5 | 0.5 | 2.75 | 5 | 5 | 5 | 5 | — | — | — | — |
| Compression Set at | 8.82 | 8.82 | 5.88 | 8.82 | 8.82 | 7.35 | 16.00 | 14.00 | 12.00 | 16.00 | 16.00 |
| 250° C., 25%, 70 hour | | | | | | | | | | | |
| Compression Set at | 74.00 | 76.00 | 76.00 | 70.00 | 90.00 | 84.00 | 65.31 | 100.00 | 80.00 | 100.00 | 84.00 |
| 350° C., 18%, 70 Hour | | | | | | | | | | | |
| Sticking Force 24 hour | 28.19 | 38.07 | 32.79 | 33.25 | 29.71 | 27.45 | 31.09 | 60.93 | 52.90 | 47.84 | 48.58 |
| @ 392° F. 25% deflection | | | | | | | | | | | |

### Example 3

Two inventive compositions, Examples 10 and 11, were prepared along with a control Comparative Example K for further particulation testing similar to that of Example 1. The components of the compositions are shown below in Table C, where Polymer D is from Lodestar in the United States for Federal State Unitary Enterprise S.V. Lebedev Institute of Synthetic Rubber of Petersburg, Russia, known as PFK-300 and the microdiamond powder had an average particle size of 0.250 micron and was from Eastwind Diamond Abrasives.

The compositions in Table C were tested by forming test 214 O-rings for each of the three formulations (Comparative Example K, Example 10 and Example 11). The sample O-rings were exposed to a remote NF₃ process at 250° C. The samples were then installed in a small valve, and the valve was cycled at a rate of 1 cycle/1.6 seconds. The samples were loaded into the valve and it was heated to 250° C. Clean, filtered air was drawn through the valve during cycling and fed into a particle counter. Particle counts were collected during the entire test. The total particle counts in 36,000 seconds are shown in Table C. Comparative Example K which had no filler had the highest total particle counts. The inventive compositions demonstrated a significant reduction in particulation.

TABLE C

| | Comp. | | |
|---|---|---|---|
| Ingredients | Ex. K | Ex. 10 | Ex. 11 |
| Polymer D | 100 | 100 | 100 |
| DPIA-65 | 3 | 3 | 3 |
| Microdiamond | — | 30 | 40 |
| Total particle counts | 2.42E+05 | 1.69E+04 | 6.08E+03 |

### Example 4

In this Example, compositions as noted in Example 3 were prepared using a plasma-resistant polymer (Polymer D), the same curative and an additional compound, Example 12, having somewhat less microdiamond that Example 10 as noted below in Table D. The compositions were evaluated for their physical properties as well as for their plasma resistance in a fluorine containing plasma (NF₃) and an oxygen containing plasma (O₂). The samples were tested and even at the higher loading values of microdiamond used, provided improved physical properties, excellent compression set and a significantly improved resistance to the plasmas used.

TABLE D

| | | | | |
|---|---|---|---|---|
| | Comp. | | | |
| INGREDIENTS | Ex. K | Ex. 12 | Ex. 10 | Ex. 11 |

| | | | | |
|---|---|---|---|---|
| Polymer D | 100 | 100 | 100 | 100 |
| DPIA-65 | 3 | 3 | 3 | 3 |
| Microdiamond | — | 20 | 30 | 40 |

Physical Properties

| Tensile Strength, psi | | 885 | 2008 | 2462 | 2741 |
|---|---|---|---|---|---|
| Elongation, % | | 166 | 132 | 122 | 112 |
| Modulus @ 100%, psi | | 263 | 1003 | 1615 | 2247 |
| Modulus @ 50%, psi | | 142 | 259 | 362 | 527 |
| Specific Gravity | | 2.03 | 2.18 | 2.25 | 2.31 |
| Hardness, Type M | | 69.5 | 77.5 | 80.8 | 83.8 |
| Hardness, Type A | | 64.0 | 73.1 | 76.1 | 79.4 |
| Compression Set, % | 1 | —* | 2.94 | 2.94 | 2.94 |
| 70 hrs @ 200° C. | 2 | 2.94 | 2.94 | 2.94 | 2.94 |
| 25% Deflection | Average (%) | 2.94 | 2.94 | 2.94 | 2.94 |
| Compression Set, % | 1 | 4.17 | 4.17 | 4.17 | 4.17 |
| 70 hrs @ 250° C., | 2 | 4.17 | 4.17 | 4.17 | 4.17 |
| 18% Deflection | Average (%) | 4.17 | 4.17 | 4.17 | 4.17 |

Direct NF3 Plasma, wt. %

| | | | | |
|---|---|---|---|---|
| 1 | 21.15 | 1.13 | 0.71 | 0.52 |
| 2 | 17.80 | 1.15 | 0.69 | 0.54 |
| 3 | 13.39 | 0.98 | 0.69 | 0.49 |
| Average | 17.440 | 1.085 | 0.696 | 0.515 |

Direct O2 Plasma, wt. %

| | | | | |
|---|---|---|---|---|
| 1 | 4.42 | 1.79 | 0.75 | 0.55 |
| 2 | 4.54 | 1.13 | 0.78 | 0.61 |
| 3 | 5.06 | 1.21 | 0.80 | 0.59 |
| Average | 4.671 | 1.378 | 0.777 | 0.584 |

*crumbled

### Example 5

Compounds were prepared for evaluation of the resulting elastomer articles for plasma resistance (measured in percentage weight loss after plasma exposure) using a fluorine-based plasma (NF₃) and in an oxygen-based plasma (O₂). The compositions and test results are shown below in Table E. The compound samples for physical and plasma resistance testing were molded into test O-rings. Comparative Example L did not include microdiamond. Examples 13 and 14 were prepared using the same composition which was a blend of Polymer A and B used in Example 1, and including as a curative NphAF described above as used in Example 1, but each included microdiamond at a different level within the composition.

TABLE E

| | Comp. | | |
|---|---|---|---|
| | Ex. L | Ex. 13 | Ex. 14 |
| Polymer A | 50 | 50 | 50 |
| Polymer B | 50 | 50 | 50 |
| NphAF | 1.6 | 1.6 | 1.6 |
| Microdiamond | Control | 5 | 10 |

Physical Properties

| Tensile Strength, psi | | 2641 | 3295 | 3439 |
|---|---|---|---|---|
| Elongation, % | | 249 | 246 | 238 |
| Modulus @ 100%, psi | | 569 | 707 | 895 |
| Modulus @ 50%, psi | | 332 | 387 | 460 |
| Specific Gravity | | 2.06 | 2.11 | 2.15 |
| Hardness, Type A | | 74 | 75 | 78 |
| Compression Set, % | 1 | 47 | 47 | 47 |
| 70 hrs @ 300° C. | 2 | 47 | 42 | 42 |
| 14% Deflection | Average (%) | 47 | 45 | 45 |
| Compression Set, % | 1 | 47 | 42 | 42 |
| 70 hrs @ 325° C. | 2 | 47 | 42 | 42 |
| 14% Deflection | Average (%) | 47 | 42 | 42 |

Direct NF3 Plasma, wt. %

| | | | |
|---|---|---|---|
| 1 | 5.46 | 2.59 | 1.90 |
| 2 | 5.54 | 2.39 | 1.88 |
| 3 | 4.76 | 2.12 | 1.66 |
| Average (weight %) | 5.259 | 2.510 | 1.817 |

Direct O2 Plasma, wt. %

| | | | |
|---|---|---|---|
| 1 | 3.42 | 2.34 | 1.47 |
| 2 | 3.65 | 2.41 | 1.62 |
| 3 | 3.77 | 2.57 | 1.64 |
| Average (weight %). | 3.617 | 2.443 | 1.577 |

The results show that in comparison to the control, the inventive Examples 13 and 14 generally maintained or improved physical properties, retained or improved compression set, while also reducing the level of weight loss from plasma exposure in both the fluorine-containing plasma and the oxygen-containing plasma.

### Example 6

In this Example, Comparative Examples M, N, O and P were prepared without microdiamonds and inventive Examples 15-21 were prepared using curable perfluoropolymers, Tecnoflon® PFR 5910M (Polymer E), Tecnoflon® PFR 5920M (Polymer F), Tecnoflon® PFR 06HC (Polymer G) and Polymer D. Polymer D was used in the same compound inventive Examples and using the same components as included in Example 4, Table D, specifically inventive Examples 10-12.

Examples 15-16 and Comparative Example M were prepared using Polymer E and a peroxide curative Varox® DBPH, with the inventive Examples having varying amounts of microdiamond.

Inventive Examples 17 and 18 and Comparative Example N were prepared using Polymer F and Varox® DBPH, also with varying amounts of microdiamonds in Examples 17 and 18.

Inventive Examples 19 and 20 and Comparative Example 0 were prepared using blends of Polymers E and F and Varox® DBPH, and varying amounts of microdiamond in Examples 19 and 20.

Example 21 was prepared using Polymer G with a PTFE lubricant, PTFE LSF, and a peroxide cure system including Varox® DBPH and DIAK #7. The control for this Example, Comparative Example P did not include microdiamond, while Example 21 included 5 parts microdiamond per hundred parts of the base polymer, Polymer G. The Compositions are shown below in Table F.

The compositions were all subjected to varying levels of hydrogen-containing plasma using the plasma exposure test as described above. Thus, pure hydrogen plasma (100% hydrogen) as well as blends of hydrogen plasma with a fluorine-containing plasma (CF₄), an oxygen-containing plasma (O₂) and a nitrogen plasma (N₂) were prepared. The plasma was provided to the test in each instance at a pressure of 600 mT, a power of 300 W, a temperature of 200° C. and was applied for a time of one hour. The blended plasmas used had varying amounts of hydrogen plasma within the plasma delivered to the test ranging from 100% for a pure hydrogen plasma exposure, 70% for a blend with the nitrogen-containing plasma and 50% in blends with the fluorine-containing plasma and with the oxygen-containing plasma.

After exposure to these varying plasmas, in all instances the weight loss decreased for the inventive Examples was lower than that of the Comparative Examples with the same formulations but lacking the microdiamond. In addition, the weight loss became lower in the Inventive Examples as the content of the microdiamond increased. The weight loss data for the varying plasmas and Examples may also be found in Table F. This remained true in each of the cured perfluoroelastomer articles tested, each of which uses a perfluoropolymer already employed for use in end applications where high levels of chemical- or plasma-resistance and low particulation is indicated. Even when using such polymers in an unfilled or clean-filled state, the weight loss in plasma was lowered.

TABLE F

| | Comp | | | Comp. | | | Comp. | | | Comp. | | | | |
|---|---|---|---|---|---|---|---|---|---|---|---|---|---|---|
| Ingredients | Ex. M | Ex. 15 | Ex. 16 | Ex. N | Ex. 17 | Ex. 18 | Ex. O | Ex. 19 | Ex. 20 | Ex. P | Ex. 21 | Ex. 12 | Ex. 10 | Ex. 11 |
| Polymer D | | | | | | | | | | | | 100 | 100 | 100 |
| Polymer E | 110 | 110 | 110 | | | | 50 | 50 | 50 | | | | | |
| Polymer F | | | | 100 | 100 | 110 | 40 | 40 | 40 | | | | | |
| Polymer G | | | | | | | | | | 100 | 100 | | | |
| DPIA-65 | | | | | | | | | | | | 3 | 3 | 1.5 |
| Varox ® DBPH | 1.5 | 1.5 | 1.5 | 1.5 | 1.5 | 1.5 | 1.5 | 1.5 | 1.5 | 0.8 | 0.8 | | | |
| DIAK #7 | | | | | | | | | | 1.5 | 1.5 | | | |
| PTFE LSF | | | | | | | | | | 25 | 25 | | | |
| Microdiamond | — | 5 | 10 | — | 5 | 10 | — | 5 | 10 | — | 5 | 20 | 30 | 40 |

Weight Loss %

| | | | | | | | | | | | | | | |
|---|---|---|---|---|---|---|---|---|---|---|---|---|---|---|
| 100% | 0.19 | 0.16 | 0.13 | 0.19 | 0.14 | 0.10 | 0.17 | 0.15 | 0.13 | 0.47 | 0.35 | 0.24 | 0.18 | 0.16 |
| Hydrogen | | | | | | | | | | | | | | |
| 50% Hydrogen/ | 0.26 | 0.23 | 0.20 | 0.26 | 0.23 | 0.20 | 0.25 | 0.18 | 0.17 | 0.26 | 0.23 | 0.22 | 0.18 | 0.17 |
| 50% Fluorine | | | | | | | | | | | | | | |
| (CF₄) | | | | | | | | | | | | | | |
| 50% Hydrogen/ | 0.39 | 0.31 | 0.26 | 0.39 | 0.28 | 0.23 | 0.38 | 0.31 | 0.24 | 0.42 | 0.35 | 0.31 | 0.26 | 0.21 |
| 50% Oxygen | | | | | | | | | | | | | | |
| 70% Hydrogen/ | 0.16 | 0.14 | 0.13 | 0.16 | 0.14 | 0.15 | 0.17 | 0.16 | 0.14 | 0.42 | 0.35 | 0.23 | 0.18 | 0.16 |
| 30% Nitrogen | | | | | | | | | | | | | | |
| Total | 1.00 | 0.84 | 0.72 | 1.00 | 0.79 | 0.68 | 0.97 | 0.80 | 0.68 | 1.57 | 1.28 | 1.00 | 0.80 | 0.70 |

### Example 7

To further evaluate the physical properties and plasma resistant properties derived from the invention herein, a composition using Polymer G was prepared with and without microdiamond. Samples were made as noted above and tested for physical properties, compression set and plasma resistance in both a nitrogen-containing plasma (NF3) and an oxygen-containing plasma (02). The composition and test results are shown in Table G for both the Comparative Example Q and the Inventive Example 22.

TABLE G

| | | |
|---|---|---|
| | Comp. | |
| INGREDIENTS | Ex. Q | Ex. 22 |

| | | |
|---|---|---|
| Polymer G | 100 | 100 |
| PTFE | 25 | 25 |
| Microdiamond | Control | 5 |
| DIAK No. 7 | 1.5 | 1.5 |
| Varox ® DBPH | 0.8 | 0.8 |

Physical Properties

| Tensile Strength, psi | | 1810 | 2601 |
|---|---|---|---|
| Elongation, % | | 175 | 185 |
| Modulus @ 100%, psi | | 772 | 872 |
| Modulus @ 50%, psi | | 462 | 486 |
| Specific Gravity | | 2.075 | 2.105 |
| Hardness, Type A | | 79 | 79.5 |
| Compression Set, % | 1 | 28.57 | 28.57 |
| 70 hrs @ 200° C. | 2 | 25.71 | 25.71 |
| 25% Deflection | Average % | 27.41 | 27.41 |

Direct NF3 Plasma, wt. %

| | | |
|---|---|---|
| 1 | 5.81 | 3.52 |
| 2 | 5.58 | 3.00 |
| 3 | 4.64 | 2.44 |
| Average weight % | 5.344 | 2.985 |

Direct O2 Plasma, wt. %

| | | |
|---|---|---|
| 1 | 2.76 | 1.95 |
| 2 | 2.97 | 2.04 |
| 3 | 2.99 | 2.13 |
| Average weight % | 2.905 | 2.041 |

The test results show that once again in a composition that would have very good properties for use in a semiconductor or similar application requiring low particulation, good physical properties and a high level of plasma resistance, all of these properties were maintained as in the case of compression set or improved by use of the microdiamond.

### Example 8

Further tests were conducted using varying amounts of Technoflon® PFR X10650 (Polymer I) and Technoflon® X10750 (Polymer J), each of which are Tecnoflon® FFKMs from Solvay® for use in applications requiring thermal and chemical resistance. Polymer I was used alone and in blends with Polymer J. They were cured with a BOAP and the compounds cured in Comparative Examples R, S and T without inclusion of microdiamond. In inventive Examples 23-28, varying amounts of microdiamond were incorporated. The compositions were molded into test samples for 20 min. at 170° C. and postcured at 8/16 hr at 290° C. in air. The samples were all tested with respect to their physical properties as well as the compression set and their resistance to a nitrogen-containing plasma (NF₃) and an oxygen-containing plasma (O₂). The data for all testing and the compositions are shown below in Table H. A comparison of the varying compositions demonstrates that regardless of the combination of polymers and formulations used, in all cases, the physical properties were retained or improved, the compression set remained about the same and the weight loss in plasma was significantly reduced.

TABLE H

| | Comp. | | | Comp. | | | Comp. | | |
|---|---|---|---|---|---|---|---|---|---|
| INGREDIENTS | Ex. R | Ex. 23 | Ex. 24 | Ex. S | Ex. 25 | Ex. 26 | Ex. T | Ex. 27 | Ex. 28 |
| BOAP | 0.9 | 0.9 | 0.9 | 1.1 | 1.1 | 1.1 | 0.9 | 0.9 | 0.9 |
| Polymer I | 100 | 100 | 100 | 100 | 100 | 100 | 80 | 80 | 80 |
| Polymer J | | | | | | | 20 | 20 | 20 |
| Microdiamond | — | 5 | 10 | — | 5 | 10 | — | 5 | 10 |

Physical Properties

| | | | | | | | | | |
|---|---|---|---|---|---|---|---|---|---|
| Tensile Strength, psi | 1379 | 2130 | 2205 | 1464 | 1947 | 2027 | 1490 | 1910 | 2419 |
| Elongation, % | 268 | 265 | 243 | 260 | 247 | 224 | 263 | 249 | 246 |
| Modulus @ 100%, psi | 296 | 365 | 442 | 303 | 370 | 455 | 329 | 418 | 528 |
| Modulus @ 50%, psi | 195 | 228 | 256 | 197 | 228 | 260 | 216 | 263 | 310 |
| Specific Gravity | 2.06 | 2.11 | 2.15 | 2.06 | 2.11 | 2.11 | 2.07 | 2.12 | 2.16 |
| ATG Hardness, Type M | 75 | 74 | 74 | 75 | 78 | 80 | 71 | 81 | 80 |
| ATG Hardness, Type A | 67 | 68 | 70 | 67 | 69 | 71 | 69 | 74 | 74 |
| Compression Set, %, 70 hrs | 17.65 | 14.71 | 14.71 | 14.71 | 14.71 | 14.71 | 20.59 | 17.65 | 23.53 |
| @ 200° C., 25% Deflection | 17.65 | 14.71 | 14.71 | 14.71 | 11.76 | 14.71 | 20.59 | 17.65 | 20.59 |
| Average % | 17.65 | 14.71 | 14.71 | 14.71 | 13.24 | 14.71 | 20.59 | 17.65 | 22.06 |
| Compression Set, %, 70 hrs | 24.00 | 24.00 | 24.00 | 20.00 | 24.00 | 24.00 | 28.00 | 28.00 | 28.00 |
| @ 250° C., 18% Deflection | 24.00 | 24.00 | 24.00 | 20.00 | 24.00 | 20.00 | 28.00 | 24.00 | 28.00 |
| Average % | 24.00 | 24.00 | 24.00 | 20.00 | 24.00 | 22.00 | 28.00 | 26.00 | 28.00 |
| Compression Set, % 70 hrs | 68.00 | 60.00 | 64.00 | 52.00 | 60.00 | 64.00 | 76.00 | 72.00 | 76.00 |
| @ 300° C., 18% Deflection | 68.00 | 60.00 | 64.00 | 52.00 | 56.00 | 64.00 | Split | 72.00 | 72.00 |
| Average % | 68.00 | 60.00 | 64.00 | 52.00 | 58.00 | 64.00 | 76.00 | 72.00 | 74.00 |
| Direct NF3 Plasma, wt. %.-1 | 11.69 | 3.77 | 2.19 | 9.95 | 3.64 | 2.33 | 10.56 | 3.49 | 2.24 |
| Direct NF3 Plasma, wt. %-2 | 9.91 | 2.37 | 2.09 | 8.26 | 3.39 | 2.08 | 8.55 | 3.21 | 2.02 |
| Direct NF3 Plasma, wt. %-3 | 7.02 | 3.03 | 1.88 | 5.96 | 2.94 | 1.83 | 5.99 | 3.05 | 1.75 |
| Direct NF3 Plasma, wt. %-Average | 9.540 | 3.060 | 2.054 | 8.070 | 3.321 | 2.079 | 8.354 | 3.252 | 2.004 |
| Direct O2 Plasma, wt. %-1 | 3.66 | 2.43 | 1.87 | 3.68 | 2.43 | 1.89 | 3.09 | 2.30 | 1.75 |
| Direct O2 Plasma, wt. %-2 | 3.95 | 2.63 | 1.95 | 3.91 | 2.54 | 2.00 | 3.46 | 2.48 | 1.90 |
| Direct O2 Plasma, wt. %-3 | 3.95 | 2.63 | 2.05 | 3.96 | 2.61 | 2.00 | 3.56 | 2.53 | 1.92 |
| Direct O2 Plasma, wt. %-Average | 3.854 | 2.564 | 1.953 | 3.849 | 2.528 | 1.966 | 3.367 | 2.436 | 1.856 |

### Example 9

A fluoroelastomer (FKM) composition was prepared based on the use of a commercial polymer, Tecnoflon® P 959 from Solvay (Polymer H). The polymer was cured using a peroxide cure system based on Varox® DBPH and DIAK #7. In Comparative Example U, no microdiamond is provided, while in inventive Examples 29 and 30, varied amounts of microdiamond are incorporated in the compositions. The compositions were milled at 120° F., using a mixer, molded for 10 min. at 310° F. and post cured 30-2-45 hr. at 450° F. in air. As with the various FFKM Examples above, in the FKM, the same effect is seen wherein the physical properties are improved, and the compression set is the same or improved. In this Example it is substantially improved. Further, the sticking force is also reduced which is a further advantage in many end applications. The compositions and test results are included below in Table I.

TABLE I

| | Comp. | | |
|---|---|---|---|
| INGREDIENTS | Ex. U | Ex. 29 | Ex. 30 |
| Polymer H | 100 | 100 | 100 |
| DIAK No. 7 | 3.5 | 3.5 | 3.5 |
| Varox ® DBPH | 1 | 1 | 1 |
| Microdiamond | | 1 | 5 |

RPA 310° F. for 15 min

| | | | |
|---|---|---|---|
| T2, min | 2.97 | 2.65 | 2.31 |
| T10, min | 1.54 | 1.47 | 1.40 |
| T50, min | 4.10 | 3.70 | 3.32 |
| T90, min | 9.37 | 8.34 | 7.63 |
| ML, lb-in | 0.268 | 0.282 | 0.273 |
| MH, lb-in | 6.105 | 6.321 | 6.668 |

Physical Properties

| | | | |
|---|---|---|---|
| Tensile Strength, psi | 1710 | 2101 | 2717 |
| Elongation, % | 343 | 346 | 356 |
| Modulus @ 100%, psi | 155 | 163 | 181 |
| Modulus @ 50%, psi | 110 | 114 | 123 |
| Specific Gravity | 1.89 | 1.90 | 1.93 |
| ATG Hardness, Type M | 63 | 66 | 68 |
| ATG Hardness, Type A | 55 | 56 | 57 |
| Compression Set, % | 20.00 | 14.71 | 14.71 |
| 70 hrs @ 200° C., | 20.00 | 14.71 | 14.71 |
| 25% Deflection | | | |
| Average % | 20.00 | 14.71 | 14.71 |

Sticking Force, lbf

| | | | |
|---|---|---|---|
| 1 | 44.49 | 26.37 | 29.37 |
| 2 | 36.95 | 30.31 | 31.16 |
| 3 | 44.17 | 29.10 | 28.05 |
| Median | 44.17 | 29.10 | 29.37 |

Cool Set, %

| | | | |
|---|---|---|---|
| 70 hrs @ 200° C., | 37.14 | 29.41 | 32.35 |
| 25% Deflection, | 37.14 | 29.41 | 32.35 |
| RT, 24 hrs | | | |
| Average % | 37.14 | 29.41 | 32.35 |

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A curable fluorine-containing elastomer composition comprising
at least one curable fluoropolymer comprising at least one fluorinated monomer, and at least one fluorine-containing cure site monomer comprising at least one cure site; and
microdiamond particles having an average particle size of greater than 0.10 micron to about 100 microns.

2. The curable fluorine-containing elastomer composition according to claim 1, wherein the microdiamond particles have an average particle size of greater than 0.1 micron to about 10 microns.

3. The curable fluorine-containing elastomer composition according to claim 2, wherein the microdiamond particles have an average particle size of about greater than 0.1 micron to about 5 microns.

4. The curable fluorine-containing elastomer composition according to claim 2, wherein the microdiamond particles have an average particle size of about 0.20 micron to about 2 microns.

5. The curable fluorine-containing elastomer composition according to claim 4, wherein the microdiamond particles have an average particle size of about 0.25 micron to about 1 micron.

6. The curable fluorine-containing elastomer composition according to claim 1, wherein the microdiamond particles have an average particle size of about 0.25 micron to about 0.5 micron.

7. The curable fluorine-containing elastomer composition according to claim 1, wherein the microdiamond particles have a shape selected from spherical particles, fibers or flasks.

8. The curable fluorine-containing elastomer composition according to claim 1, wherein the microdiamond particles are natural microdiamond particles.

9. The curable fluorine-containing elastomer composition according to claim 1, wherein the microdiamond particles are synthetic microdiamond particles.

10. The curable fluorine-containing elastomer composition according to claim 1, wherein the microdiamond particles are a blend of natural microdiamond particles and synthetic microdiamond particles.

11. The curable fluorine-containing elastomer composition according to claim 1, wherein the particles are present in an agglomerated or aggregate form.

12. The curable fluorine-containing elastomer composition according to claim 1, wherein the composition comprises about 0.1 to about 100 parts of microdiamond particles per 100 parts by weight of the at least one curable fluoropolymer.

13. The curable fluorine-containing elastomer composition according to claim 12, wherein the composition comprises about 1 to about 50 parts of microdiamond particles per 100 parts by weight of the at least one curable fluoropolymer.

14. The curable fluorine-containing elastomer composition according to claim 13, wherein the composition comprises about 2 to about 20 parts of microdiamond particles per 100 parts b weight of the at least one curable fluoropolymer.

15. The curable fluorine-containing elastomer composition according to claim 1, wherein the at least one curable fluoropolymer is a curable perfluoropolymer, the at least one fluorinated monomer is tetrafluoroethylene and the perfluoropolymer further comprises a perfluoroalkylvinyl ether monomer, and wherein the at least one fluorine-containing cure site monomer is a perfluorinated cure site monomer.

16. The curable fluorine-containing elastomer composition according to claim 15, further comprising at least one curative.

17. The curable fluorine-containing elastomer composition according to claim 16, wherein the curative is a peroxide cure system.

18. The curable fluorine-containing elastomer composition according to claim 1, wherein the at least one curable fluoropolymer is a curable perfluoropolymer, the at least one fluorinated monomer is tetrafluoroethylene, the curable perfluoropolymer further comprises a perfluoroalkylvinyl ether monomer, and wherein the curable perfluoropolymer comprises fluoroplastic particles therein.

19. The curable fluorine-containing elastomer composition according to claim 18, further comprising at least one curative.

20. The curable fluorine-containing elastomer composition according to claim 19, wherein the curative is a peroxide cure system.

21. The curable fluorine-containing elastomer composition according to claim 1, wherein the curable fluoropolymer is a perfluoropolymer, the at least one fluorinated monomer is tetrafluoroethylene and the perfluoropolymer further comprises a perfluoroalkylvinyl ether monomer, and there are at least two of the fluorine-containing cure site monomers, each having at least one cure site.

22. The curable fluorine-containing elastomer composition according to claim 21, further comprising at least one curative.

23. The curable fluorine-containing elastomer composition according to claim 22, wherein one of the curatives is a peroxide cure system.

24. The curable fluorine-containing elastomer composition according to claim 22, wherein the composition comprises a blend of the curable perfluoropolymer with a second curable perfluoropolymer comprising tetrafluoroethylene, a second perfluoroalkylvinyl ether monomer and a perfluorinated cure site monomer, and wherein the second perfluoropolymer comprises fluoroplastic particles therein, and the composition further comprises at least two curatives.

25. The curable fluorine-containing elastomer composition according to claim 24, wherein a range of a ratio of a weight percent of first curable perfluoropolymer to a weight of the second curable perfluoropolymer is about 5:95 to about 95:5.

26. The curable fluorine-containing elastomer composition according to claim 25, wherein the range of the ratio of the weight percent of the first curable perfluoropolymer to the second curable perfluoropolymer is about 20:80 to about 80:20.

27. The curable fluorine-containing elastomer composition according to claim 26, wherein the range of the ratio of the weight percent of the first curable perfluoropolymer to the second curable perfluoropolymer is about 40:60 to about 60:40.

28. The curable fluorine-containing elastomer composition according to claim 27, wherein the range of the ratio of the weight percent of the first curable perfluoropolymer to the second curable perfluoropolymer is about 50:50.

29. The curable fluorine-containing elastomer composition according to claim 24, wherein each of the at least two cure site monomers of the first curable perfluoropolymer is present in an amount of about 0.1 to about 10 mole percent in the first curable perfluoropolymer and the at least one cure site monomer of the second curable perfluoropolymer, is present in an amount of about 0.1 to about 10 mole percent in the second curable perfluoropolymer.

30. The curable fluorine-containing elastomer composition according to claim 24, wherein the cure sites in at least two cure site monomers in the first curable perfluoropolyether are nitrogen-containing cure sites.

31. The curable fluorine-containing elastomer composition according to claim 30, wherein the first curable perfluoropolymer comprises a first cure site monomer comprising a primary cyano cure site and a second cure site monomer comprising a secondary cyano cure site.

32. The curable fluorine-containing elastomer composition according to claim 24, wherein the at least one cure site in each of the at least two cure site monomers in the first curable perfluoropolymer is selected from the group consisting of cyano, carboxyl, carbonyl, alkoxycarbonyl, and combinations thereof.

33. The curable fluorine-containing elastomer composition according to claim 24, wherein the at least two curatives are present in the composition in a total amount of about 0.2 to about 10 parts by weight per 100 parts by weight of the curable perfluoropolymers in the composition.

34. The curable fluorine-containing elastomer composition according to claim 24, wherein each of the at least two curatives is present in the composition in an amount of about 0.1 part to about 6 parts by weight per 100 parts by weight of the curable perfluoropolymers.

35. The curable fluorine-containing elastomer composition according to claim 24, wherein the at least two curatives comprises a first curative that is present in the composition in an amount of about 0.5 part to about 4 parts by weight per 100 parts by weight of the curable perfluoropolymers, and a second curative that is present in the composition in an amount of about 0.3 part to about 2 parts by weight per 100 parts by weight of the curable perfluoropolymers.

36. The curable fluorine containing elastomer composition according to claim 24, wherein the first curative is 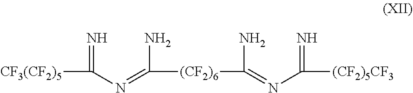
and the second curative is 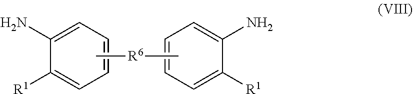
wherein each R¹ is independently —NH₂, —NHR₂, —OH or —SH; R² is a monovalent organic group; and wherein R⁶ is —SO₂, —O—, —CO—, an alkylene group of 1 to about 6 carbon atoms, a perfluoroalkylene group of 1 to about 10 carbon atoms, a single bond or a group as shown in Formula (IX):

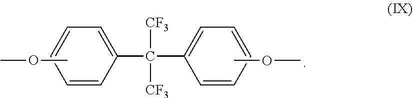

37. The curable fluorine-containing elastomer composition according to claim 36, wherein the second curative is a compound according to formula (X): 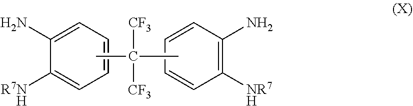
wherein R⁷ is independently selected from hydrogen, an alkyl group of 1 to about 10 carbon atoms; a partially fluorinated or perfluorinated alkyl group of 1 to 10 carbon atoms; a phenyl group; a benzyl group; or a fluorinated or partially fluorinated phenyl group; a fluorinated or partially fluorinated benzyl group; or a phenyl or an alkyl group having a function group or groups that is a lower alkyl or perfluoroalkyl group.

38. The curable fluorine-containing elastomer composition according to claim 36, wherein the second curative is a bisaminophenol or a salt thereof.

39. The curable fluorine-containing elastomer composition according to claim 24, wherein the second curable perfluoropolymer comprises a cure site monomer having a cure site selected from the group consisting of halogen, nitrogen-containing groups, carboxyl, alkoxycarbonyl and combinations thereof.

40. The curable fluorine-containing elastomer composition according to claim 24, wherein the at least two curatives are selected from the group consisting of: 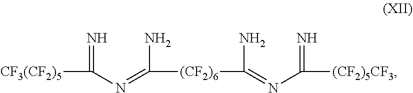
bisaminophenol and combinations thereof.

41. The curative fluorine-containing elastomer composition according to claim 40, wherein the first curative is a compound according to formula (XII) and the second curative is bisaminophenol.

42. The curable fluorine-containing elastomer composition according to claim 1, comprising a second curable fluoropolymer comprising tetrafluoroethylene and at least one second fluorine-containing monomer, one of which is a cure site monomer comprising at least one second cure site.

43. The composition according to claim 42, wherein the first curable fluoropolymer and/or the second curable fluoropolymer is a perfluoropolymer, and wherein the first curable fluoropolymer and the second curable fluoropolymer are different.

44. A cured fluorine-containing elastomer formed by curing the curable fluorine-containing composition of claim 1.

45. A molded article formed by heat curing and shaping a composition according to claim 1.

46.-84. (canceled)
